(19) United States
(12) Patent Application Publication
(10) Pub. No.: US 2025/0246949 A1
(43) Pub. Date: Jul. 31, 2025

(54) ELECTRO-MECHANICAL CONVERTERS USING FERROELECTRIC NEMATIC MATERIAL

(71) Applicant: MERCK PATENT GmbH, Darmstadt (DE)

(72) Inventors: Stefan STEFANIAK, Darmstadt (DE); Atsutaka MANABE, Darmstadt (DE); Sebastian HOFMEYER, Darmstadt (DE)

(73) Assignee: MERCK PATENT GmbH, Darmstadt (DE)

(21) Appl. No.: 18/702,248

(22) PCT Filed: Oct. 17, 2022
(86) PCT No.: PCT/EP2022/078756

§ 371 Date: Apr. 17, 2024

(30) Foreign Application Priority Data
Oct. 20, 2021 (EP) 21203786.5

(51) Int. Cl. H02K 1/04; C09K 19/02; C09K 19/12; C09K 19/20; C09K 19/34; F03G 7/00; H02K 16/04

(52) U.S. Cl. CPC H02K 1/04; C09K 19/0225; C09K 19/12; C09K 19/2007; C09K 19/3402; C09K 19/3458; F03G 7/012; H02K 16/04; C09K 2019/122; C09K 2019/123; C09K 2019/2042; C09K 2019/2078; C09K 2019/3422

(57) ABSTRACT

An improved electro-mechanical principle for converting electric power into mechanical action and vice versa using dielectrics with extreme relative permittivity. The non-magnetic devices are based on relative movement of dielectrics in the presence of electric fields. The energy-saving devices use high-performance dielectrics based on ferroelectric nematic liquid crystals. Linear and circular mechanical action is proposed involving electromechanical actuators, non-magnetic motors and related electrical generators.

### CROSS-REFERENCE TO RELATED APPLICATIONS

This application is a U.S. national stage application claiming priority under 35 U.S.C. §§ 120 and 365 (c) of and to PCT International Application No. PCT/EP2022/078756, filed Oct. 17, 2022, which claims priority under 35 U.S.C. §§ 119 (a) and 365 (b) of and to European Application No. 21203786.5, filed Oct. 20, 2021, each of which are incorporated herein in their entirety and for all purposes.

### BACKGROUND

An improved electro-mechanical principle for converting electric power into mechanical action and vice versa is described using dielectric materials (dielectrics) with extreme relative permittivity. The non-magnetic devices are based on relative movement of dielectrics in the presence of electric fields. The devices use high-performance dielectrics based on ferroelectric nematic liquid crystals. Linear and circular mechanical action is proposed involving electromechanical actuators, non-magnetic motors and related electrical generators.

Modern civilization vastly relies on the use of electricity for performing all kinds of mechanical action, mostly driven by electromagnetic motors in all kind of machinery, including but not limited to tools, pumps, vehicles, robotics, consumer electronics, toys, etc. Likewise all our electricity is generated by the action of generators based on the same electromagnetic principle.

Modern electromagnetic motors and generators are very efficient due to the available strong permanent magnets developed in the past decades. However, some drawbacks of the electromagnetic principle are immanent, which are complicated manufacturing of electrical coils, high electrical currents employed at low speed, need for vast amounts of copper and rare earth materials (e.g. neodymium) for magnet materials, heat generation, etc. The miniaturization of magnetic motors is limited due to the complication of manufacturing magnetic coils and magnetic elements at small scale.

Alternative electromechanical action is known as electrostatic attraction and repulsion. Electrostatic motors and generators have been proposed repeatedly. Usually the electrode gap is filled with air, vacuum or insulators. Usually very high voltages are used for operation. At moderate voltages mechanical output was much inferior to magnetic motors and it gained little commercial interest so far.

There is a high interest for improvement of alternative electromechanical converters. Most electromagnetic motors achieve their optimum power efficiency only at a sufficient level of speed. Therefore machines which need little power at low velocity or at standstill are desirable. A simple construction principle for an actuator or motor is highly attractive, especially when it comes to miniaturization and cost savings. A non-magnetic power system is also interesting from the view of working in environments sensitive to electromagnetic disturbances.

The dielectric permittivity of materials is well known for most materials. It can be determined by the measurement of the capacitance of a capacitor filled with the material compared with a void capacitor. The dimensionless relative dielectric permittivity (εᵣ) is defined as

εᵣ=ε/ε₀,

wherein ε is the permittivity and co the vacuum permittivity. The value of ε and εᵣ can depend from frequency and strength of electric field, spatial direction, temperature and history. Here the static or low frequency value of εᵣ is used. Most materials have a value of εᵣ below 10. Some polar liquids like water or nitromethane have double digit values with εᵣ up to 10² (at 1 kHz). One of the prominent high dielectric permittivity materials is e.g. barium titanate. While its permittivity value is reported to reach up to about 1·10⁴, such values are only obtained while a strong electric field is present. An electric field acts on dielectric materials and vice versa. From theory of electrostatics the energy density inside a capacitor depends linearly from the relative dielectric permittivity (εᵣ) of the dielectric material. In the case where the dielectric fills a capacitor under a constant voltage only partly, it is pulled mechanically inside the electric field maximizing the energy density inside the capacitor. The force on the dielectric can be expressed as a pressure p on the surface of a dielectric, which surface is tangential to the electric field E:

$$p = {ε}_{0} / 2 ( {ε}_{r} - 1 ) \cdot {E}^{2}$$

wherein ε₀ is the dielectric constant in vacuum (about 8.8.10⁻¹² CV⁻¹ m⁻¹) and E is the electric field strength (Vm⁻¹). The dielectric constant of air is neglected here.

In the case of different dielectrics with relative dielectric values εᵣ¹ and εᵣ² inside the electric field the value of the pressure on the separating boundary is

$$p = 1 / 2 \cdot {ε}_{0} ( \vert {ε}_{r}^{1} - {ε}_{r}^{2} \vert ) \cdot {E}^{2}$$

In previous years, the areas of application for liquid crystal compounds have been considerably expanded to various types of display devices. Most of these devices employ the enantiotropic nematic liquid crystal phase, including all common LCD television sets, LCD desktop monitors and mobile LCD devices. Some alternative liquid crystalline phases are known, like ferroelectric smectic phases or blue phases. However, a ferroelectric nematic phase (N_{f}-LC phase) had been postulated by theory for decades only, without finding a suitable liquid crystalline material with such nematic and ferroelectric property. Only recently, a few chemical structures have been reported to show ferroelectric nematic behaviour. Exemplary, a ferroelectric nematic substance of formula C is published by Atsutaka Manabe, Matthias Bremer, Martin Kraska (2021): Ferroelectric phase at and below room temperature, Liquid Crystals, 48, 1079-1086 (DOI 10.1080/02678292.2021.1921867), which is described to have a monotropic ferroelectric nematic liquid crystalline phase (Nr-LC phase) close to ambient temperature.

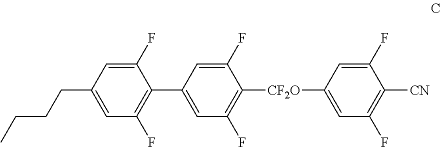

There is still need for improvement of the temperature stability of the ferroelectric nematic phase at ambient temperatures and over long periods of time.

The use of fluorinated liquid crystal substances is known to the person skilled in the art. Various compounds containing two 2,6-difluorinated 1,4-phenylene rings have already been described as liquid-crystalline or mesogenic material, such as, for example, in

the publication WO 2015/101405 A1 and various more. The compounds proposed therein are well characterized but not reported to have any ferroelectric properties.

### SUMMARY OF THE INVENTION

In a first aspect the current invention relates to an electro-mechanical conversion machine comprising two or more electrodes for generating an electric field in a space volume distributed between at least two of the electrodes, a dielectric material positioned at least partly in the space volume of said electric field between at least two of the electrodes, wherein the dielectric material can assume spatially variable positions in relation to the electrodes, and

wherein the dielectric comprises one or more liquid crystalline (LC) materials in a ferroelectric nematic (N_{f}) phase, preferably an enantiotropic ferroelectric nematic phase, preferably at temperatures from 10 to 30° C., wherein said ferroelectric nematic LC material comprises at least two compounds with a molecular structure of formula I,

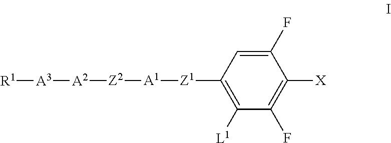

wherein
A¹ denotes

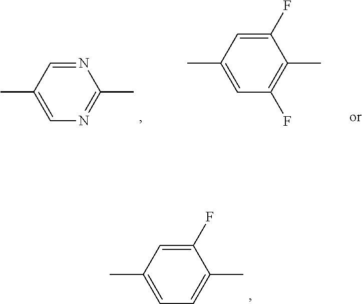

A² denotes

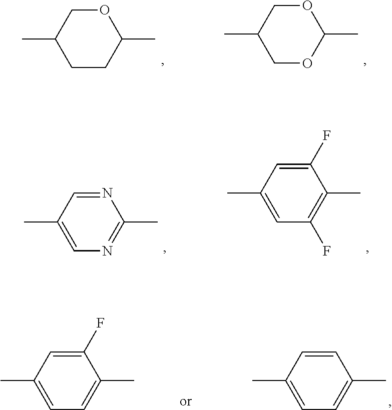

A³ denotes

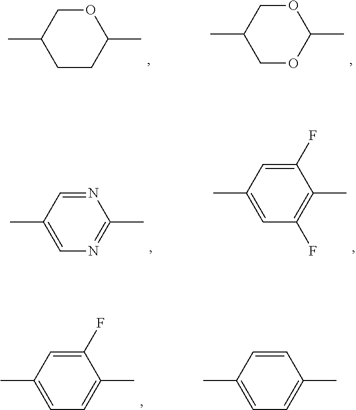

or a single bond,
R¹ is an alkyl radical having 1 to 12 C atoms, preferably 1 to 8, more preferably 1 to 6 and most preferably 1 to 5 C atoms, where, in addition, one or more CH₂ groups in these radicals may in each case be replaced, independently of one another, by —C═C—, —CF₂—O—, —OCF₂—, —CH═CH—,

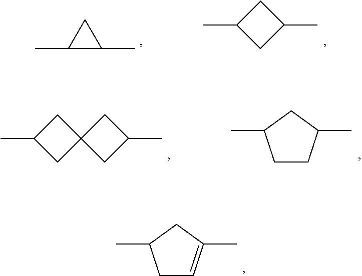

—O—, —S—, —(CO)—O— or —O—(CO)— in such a way that O/S atoms are not linked directly to one another, and in which, in addition, one or more H atoms may be replaced by halogen, or denotes H,
X is CN, F, CF₃, —OCF₃, —NCS, Cl, preferably CN or F,
L¹ is H or CH₃,
Z¹ is CF₂O or —(CO)—O— or a single bond, and
Z² is CF₂O or —(CO)—O— or a single bond.

A further aspect of the invention is a method of preparation of an electro-mechanical conversion machine comprising inserting a ferroelectric nematic liquid crystalline medium as defined above and below into a defined space volume and attaching two or more electrodes, where the electrodes define a second space volume distributed between at least two of the electrodes, and the dielectric material is positioned in contact with or partly inside the second space volume.

In one aspect of the invention the electromechanical converter converts electric impulse into a mechanical motion. In another aspect the electromechanical converter converts mechanical motion into an electric impulse.

An aspect of the invention relates to using liquid crystalline media exhibiting a ferroelectric nematic liquid crystalline phase over a substantial range of temperatures, preferably at ambient temperature. Preferably these media comprise one or more compounds of formula I, more preferably of each of the formulae IA and IB and one or more of IC-1 to IC-3 as defined below.

Ambient temperature, also sometimes called room temperature, means in a narrower sense a temperature of 20° C. here.

Application of the Nr-LC phase for technical applications would clearly benefit from applicability to ambient temperatures. Technical devices and electronic applications are usually designed to have a working range above and below ambient temperature, respectively room temperature, e.g. from 15° C. to 25° C., preferably from 0° to 50° C. and more preferably even broader.

The disclosure includes stable compounds which are suitable as component(s) of ferroelectric nematic liquid crystal media, in particular for application to the electromechanical devices of the present invention.

Surprisingly, it has been found that a liquid crystalline medium comprising several selected compounds as described below can achieve the ferroelectric phase in an highly advantageous temperature range, and certain disclosed compounds in combination are eminently suitable as components of Nr-LC media. They can be used to obtain LC media with unprecedent properties, including, but not limited to liquid crystal media for electromechanical devices making use of the high dielectric permittivity of the materials. The media and compounds used according to the invention are sufficiently stable. In particular, they are distinguished by extraordinarily high dielectric constants and in particular by very high dielectric anisotropies (As), owing to which much lower threshold voltages are necessary to uniformly align them. The compounds have reasonably good solubility for compounds having comparable properties and can be admixed with similar compounds. In addition, the compounds used according to the present invention have a high clearing point. These compounds also have relatively low melting points, or can be stably kept below their melting point as super-cooled melts. The invention enables the formation of the desired N_{f}-LC phase in a considerable working range above and below room temperature.

The high dielectric permeability enables outstanding physical performance. The high (relative) dielectric permittivity is especially advantageous for dielectrics, since it provides high relative permittivity in any volume between charged electrodes. In addition, the media have very low electric conductivity, are insulators, and are unique over conventional high-εᵣ materials (e.g. barium titanates) due to their fluid nature and responsiveness to low voltages.

### BRIEF DESCRIPTION OF THE DRAWINGS

FIG. 1 shows a graph representing the dielectric properties of Mixture Example 1 over a range of temperature of −40 to 110° C. The T/εᵣ graph measured at 10 Hz and a voltage of about 50 mV shows the values of the relative dielectric permittivity εᵣ upon cooling. Between about 5 and 55° C. the value of εᵣ has a maximum (plateau shape) with a decline towards higher temperatures. The maximum permittivity value of εᵣ at about 52° C. is 42400.

FIG. 2 shows an electromechanical actuator with two pairs of electrodes (1, 2) positioned along the path of a piston inside a tube (6). The piston comprises a housing (4) which is filled with a dielectric material (3) of ferroelectric nematic LC. A rod (5) is connected to the housing (4) of the piston for transferring motion.

FIG. 3 shows a electromechanical actuator with two pairs of electrodes (1, 2) positioned along the path of a piston (4) inside a container (6), where the piston (4) is made of low εᵣ dielectric material (dotted area). The piston (4) is positioned inside the container (6) filled with a dielectric material (3) (striped area) of ferroelectric nematic liquid crystal.

FIGS. 4a and 4b show two views of a model of an electric rotating motor with a rotator comprising a dielectric material and a stator comprising electrodes.

FIG. 4a depicts the sectional drawing of the motor with the rotor (1) that holds the cavities (2) filled with dielectric material. The dielectric material can be filled in through a opening sealed by a lid (3) (e.g. a screw) at a position away from the electrodes. Separately beside the rotor at small distance from the sides electrodes (4) of similar size as the rotor are placed. The rotor is mounted on a rotating middle axis (5), while the electrodes are static.

FIG. 4b depicts a exploded view drawing of the motor comprising the first and second sectors (1,2) of the rotor and the pairs of electrodes (3, 4, 5, 6) making up the stator. The distance of the rotor and stator is enlarged strongly for visibility (exploded view). The rotor is mounted on the axis (7) so it can rotate. The first sector (1) of the rotor comprises a the high dielectric permittivity ferroelectric nematic material, the second sector (2) comprises any other non-conductive insulating construction material or voids, which materials usually have a low relative permittivity (εᵣ<100).

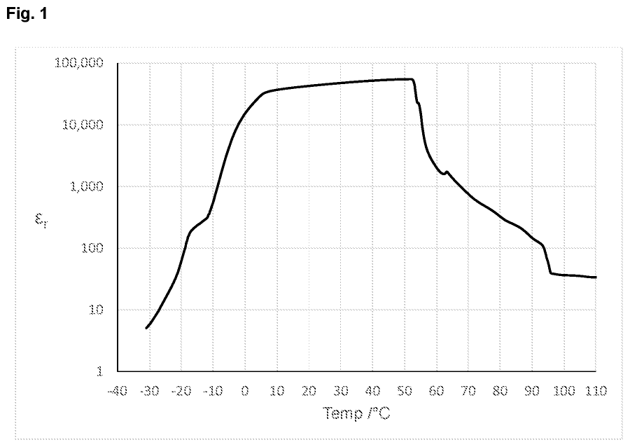

### DETAILED DESCRIPTION

The driving force for the machines presented herein is the movement of the dielectric material of higher permittivity εᵣ into the space between the charged electrodes. During this action it takes the place of any lower εᵣ material, air or vacuum. The displacement can be used to trigger a mechanical motion or the movement of a fluid medium, which can be the liquid crystal itself, air or a hydraulic liquid.

Due to the outstanding high relative dielectric permittivity of the proposed ferroelectric nematic dielectrics the obtainable mechanical forces or pressures exceed by far the values obtainable by prior art.

The movement of the dielectric is relative to the electrodes. In this sense not only the dielectric can move in or out of the space between the electrodes, but also the electrodes can move towards or away from the dielectric, or both. In a further preferred embodiment, only one electrode can move relative to the one or more other electrode(s) and the dielectric.

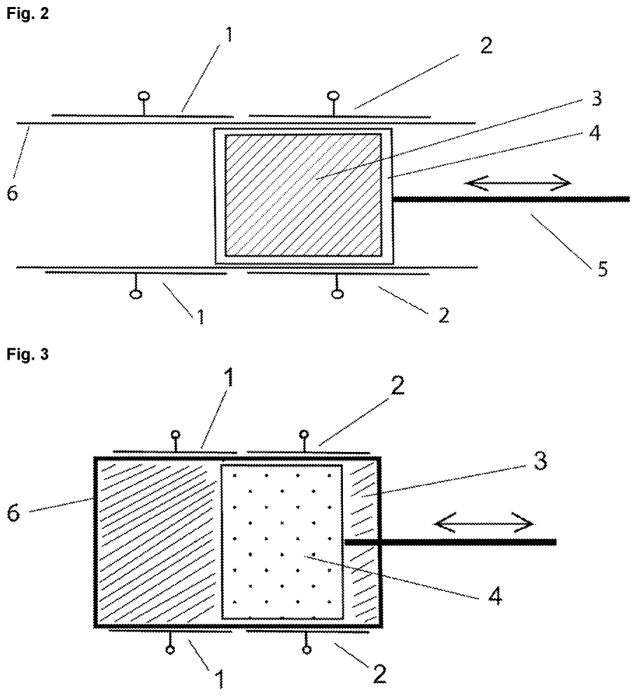

Preferably the convertor according to the invention has mechanical means for guiding a force between the electrodes and the dielectric material. In a further preferred embodiment the dielectric is enclosed in a container (housing, cf. container (4), FIG. 2), which transmits any force to and from the dielectric. Preferably the dielectric material or its housing is mechanically connected to a rod for transmission of force or to an axis for the transmission of torque and/or force (cf. rod (5), FIG. 2).

In one aspect of the invention the electro-mechanical conversion machine works as a linear electromechanical actuator. In this embodiment the movement of the machine is essentially in a linear fashion, preferably back and forth. In a preferred embodiment the machine comprises a confined space wherein the LC material is moved along a defined path by the driving electric field. This confined path can be a tube or shaft, wherein the dielectric is made to move. The medium can be a free-flowing bulk liquid or it can be a confined volume of the dielectric inside a container. The latter can be exemplary and preferably a hollow piston filled with dielectric. In a preferred embodiment the shape of the volume of dielectric is adopted to the shape of the electrodes, which are usually flat. Hence the dielectric material or its enclosing container may be a cuboid in shape. Preferably two opposite sides are flat for achieving close distance to the electrodes. Preferably the distance of the electrodes and the corresponding thickness of the dielectric is in the range from 0.1 mm to 50 mm, preferably 5 mm or less. The power of the actuator is not directly dependent from the electrode distance, but it depends strongly from the strength of the electric field (˜E2). The attainable mechanical force is relative to the area of the boundary area of the dielectric moving in the space volume between the electrodes perpendicular to the direction of motion. However, increasing the volume by a thicker electrode space will not lead to a gain in force, because increasing the electrode gap also leads to lower electric field at constant voltage at the electrodes.

The invention therefore also relates to an electro-mechanical conversion machine where the liquid dielectric material is confined in a container.

Alternatively the liquid dielectric material can be placed inside the machine as bulk liquid having spatial confinement which allows a flow of the material. The invention therefore also relates to an electro-mechanical conversion machine where the dielectric material is positioned in a flow path in said space volume and said spatially variable positions of the dielectric material correspond to a flow motion of the dielectric material in said flow path. A flow motion is triggered while the material enters the space between charged electrodes. The material will push out of said space any air or any other solid or liquid materials. This combined motion can be used mechanically in many conventional ways.

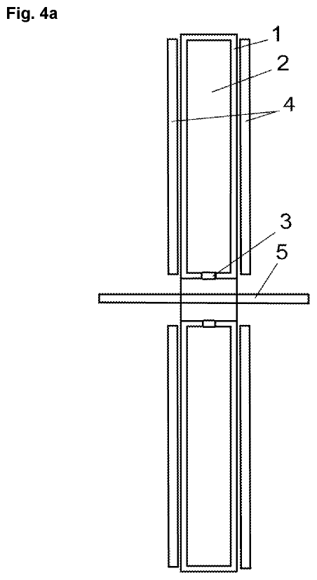

In a further preferred embodiment of the invention the electromechanical actuator comprises a solid non-ferroelectric dielectric material (preferably with εᵣ<100) inside a volume filled with N_{f}-LC dielectric material. Preferably the volume containing the both materials is inside a container, preferably a closed container. The materials both reside between the two or more electrodes. In this embodiment the lower εᵣ non-ferroelectric dielectric material acts in a reversed mode in that it is pushed out of the electric field, while the Nr-LC dielectric material enters it. FIG. 3 exemplary shows such an electromechanical conversion machine adapted for linear motion. The reservoirs of liquid N_{f}-LC dielectric on both sides of the piston (4) may communicate via a by-pass tube or via one or more pass-through holes in the piston in order to allow the medium to equilibrate between the partial volumes. In a further preferred embodiment the pressure in the volumes and the flow of liquid medium is used for a hydraulic system (hydraulic actuator). In this embodiment the low εᵣ material preferably has a close fit to the container walls, in order to work as a piston on the liquid medium.

In another aspect of the invention the electro-mechanical conversion machine works as a circular electromechanical machine, also addressed as an (electric) motor. In this embodiment the principle of a linear actuator comprising a linear motion as described above is modified into a rotation. The motor has a rotor and a stator as in a conventional magnetic motor. Preferably it has at least three pairs of electrodes and at least two separate volumes of dielectric. To perfect a recurring circular rotation as in a motor the electric field has to be a time-modulated field in alignment with the mode of rotation. Such timewise modulation of a field adapted to the recurring twist of the rotor is known from driving conventional electromagnetic motors, where a magnetic field is modulated by controlling the electric source. For the current invention, the voltage on the electrodes is supplied from a source while the dielectric enters the volume of electric field. This phase generates a physical force. No voltage is supplied while the dielectric moves out. The potential of the electrodes in this phase can be set to zero. Optionally the charge present between the pair of electrodes is reused by diverting it or by leading it (partially) into another pair of electrodes. The modulation of the electric field can be effected by a conventional commutator (e.g. with brushes on sectored twisting electrodes) or by applying respective amplified electronic signals (brushless driving). Controllers for electric motors with several circuits and a passive rotor (like e.g. step motor, brushless motor) are known to the skilled person.

The motor can exemplary be driven by a pulsed DC voltage or by a polyphase (e.g. triphase) DC or AC voltage, where each phase addresses one pair of electrodes.

The dielectric and the electrodes have advantageously rounded shapes in order to avoid excessive electric fields on the corners and edges.

### Electrical Generator

The principle is reversible for electrical power generation when an initial electric potential is applied to a pair of electrodes while the dielectric moves in and out of the volume between the electrodes. The generated electrical signals overlay the initial voltage. The variation in voltage can be transformed into a separate DC voltage or current by conventional means. In a similar setup as for the actuator and motor in this mode a mechanical motion is transformed into an variation of electric voltage at the electrodes, which can be used as a source of electric power. The power output is relative to the frequency of movement or rotation, as applicable.

The advantages of the electromechanical converters of the current invention can be seen from different perspectives, either by comparison with electromagnetic devices or by comparison with electrostatic machines.

In comparison with electromagnetic motors or generators the construction of the current converters is relative simple, since no formation of coils is needed. The electrical part is replaced by pairs of electrodes. Due to this miniaturization is easier than with coil based devices. A preferred embodiment of the current invention therefore relates to electromechanical conversion systems having a dimension of 1 mm or less, more preferably of 100 μm or less. The dimension is defined as the distance of two of the electrodes across the space volume containing the dielectric material. In another preferred embodiment the electromechanical conversion system is integrated with an electronic structure on a semiconductor chip or it is a micro electromechanical system, aka MEMS, including, but not limited, to MEMS sensors.

In terms of power efficiency it is to be noted that the different characteristics of the converters cause very low electrical current during startup or during holdup of movement. In electromagnetic motors slow movement causes excessive currents and loss of power into heat generation in the coils. A further problem in conventional motors is the loss based on electromagnetic induction in all magnetizable parts, e.g. core of coils, magnets, etc.). Such is unknown to the electrostatic rotator which is made from non-ferritic isolators. Further, the current invention employs no rare earth materials for magnets (e.g. neodymium magnets), but it is based on abundantly available organic chemicals and ordinary metal conductors.

In another aspect of the current invention the setup of the electromechanical converter is varied, in that the dielectric will rest, while electrode(s) are moving relative to the dielectric (linear or rotation). Here the mechanical commutator and the moving electrodes can be integrated into a combined moving part.

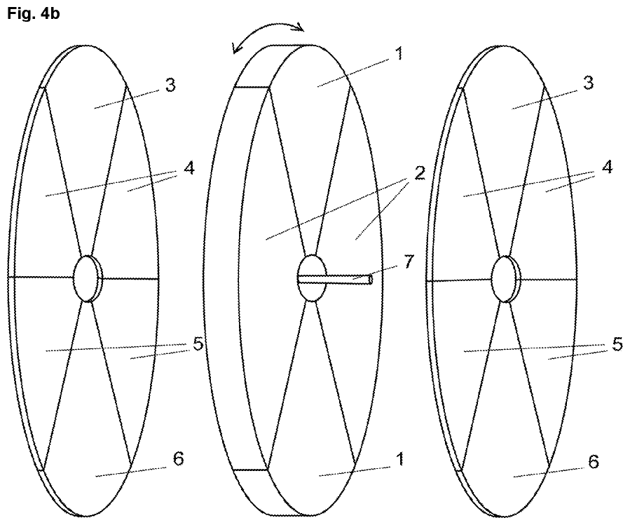

In another aspect of the current invention the electromechanical converter is modified in that parallel machines are combined into one system for more power conversion. This can be performed by stacking multiple units of alternating dielectric materials (pistons or rotors) and electrodes. Alternatively parallel units can be introduced by placing more sectors of dielectric and/or electrodes into a device according to FIG. 4a/4b.

The liquid crystal medium for use in the machine comprising at least two compounds of formula I is stable in the ferroelectric nematic phase at ambient temperature. It operates from very low voltages as 2 V to very high voltages until the breakdown voltage (arc/short circuit) as needed for varying levels of force. Prior art materials (e.g. barium titanate) do need much higher initial electric fields to attain the high values of the relative dielectric permittivity εᵣ needed for performance.

The driving scheme for motors of the capacitor type is known to the skilled person from earlier theoretical work and somewhat similar to the driving of some electromagnetic motors. The motor according to FIG. 4 is driven by a three-phased periodically alternating potential at the three electrodes. This can be effected by a suitable connected commutator or an by an external electric system. Similar driving schemes are known from conventional brushless motors with several stator coils or from step motors. The driving direction is dependent on the initial rotation caused by the first part (sector) of dielectric entering a first electric field between the electrodes, or by simply an initial rotation by external stimulus.

In the following the dielectric media comprising a ferroelectric nematic liquid crystal medium are further described.

The liquid crystalline (LC) materials in a ferroelectric nematic (N_{f}) phase which are comprised as the dielectric material (further also addressed as the liquid crystalline media) preferably comprise at least 20% by weight or more, preferably 50% by weight or more, more preferably 60% by weight or more, and even more preferably 65% by weight or more of compounds selected from compounds with a molecular structure of formula I. The material or the medium preferably comprises three, four, five or six or more of compounds of formula I. Preferably the compounds of formula I are selected from compounds of the following formulae IA and IB, preferably and independently for each formula in the percentages provided with each formula.

In a more preferred embodiment the invention uses liquid crystalline media comprising 10%, preferably 15% by weight or more of one or more compounds of formula IA,

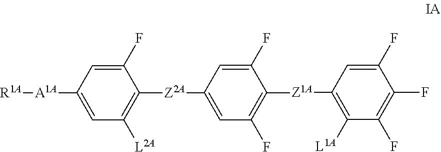

10%, preferably 15% by weight or more of one or more of compounds of formula IB,

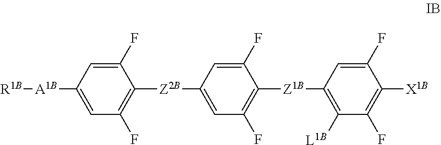

and 10%, preferably 15%, more preferably 20% by weight or more of one or more compounds selected from formula IC-1 to IC-3,

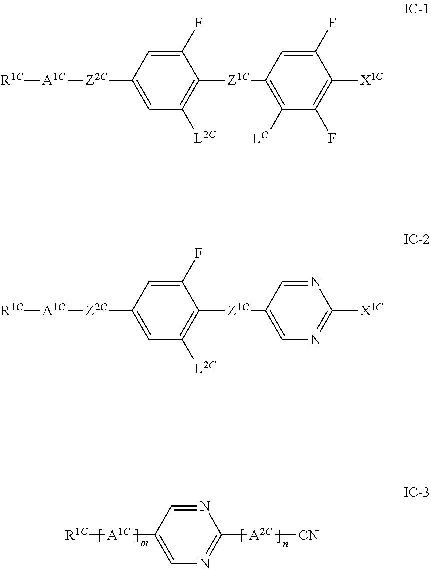

in which
X^{1B} denotes —CN or —NCS, preferably —CN,
X^{1C} denotes —CN, F, CF₃, —OCF₃, —NCS, SFs or O—CF═CF₂, preferably —CN or F, most preferably CN,
Z^{1A} and Z^{1B} independently of one another denote —(CO)—O— or —CF₂—O— or a single bond, preferably —(CO)—O— or —CF₂—O—,
Z^{2A} and Z^{2B} independently of one another denote a single bond, —(CO)—O—or —CF₂—O—, preferably a single bond,
Z^{1C} and Z^{2C} one of the both groups denotes —(CO)—O— or —CF₂—O— and the other a single bond, preferably Z^{1C} is —(CO)—O— or —CF₂—O— and Z²° C. is a single bond,
L^{1A}, L^{1B} and L^{1C} independently of each other denote H or CH₃, preferably H,
L^{2A} is F or H, preferably F,
L^{2C} is F or H, preferably F,
A^{1A} denotes

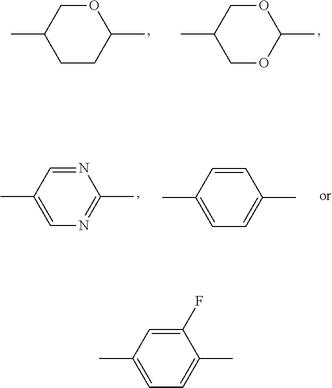

preferably

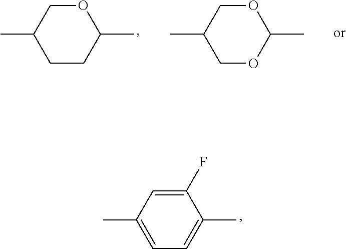

most preferably

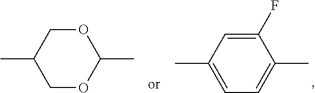

A^{1B} denotes

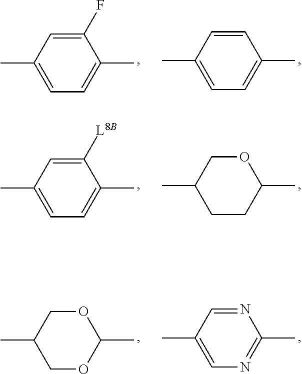

preferably

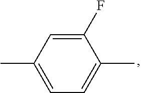

wherein L^{8B} denotes alkyl, alkoxy or alkoxyalkyl, each with 1 to 7 C atoms, preferably CH₃, OCH₃, OCH₂CH₃, CH₂OCH₃, CH₂OCH₂CH₃. CH₂CH₂OCH₃, CH₂CH₂OCH₂CH₃ or CH₂CH₂CH₂OCH₃,
A^{1C} independently denotes

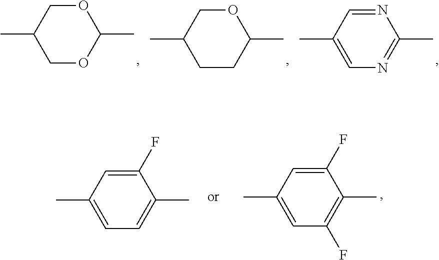

preferably

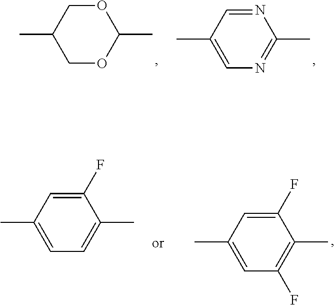

most preferably

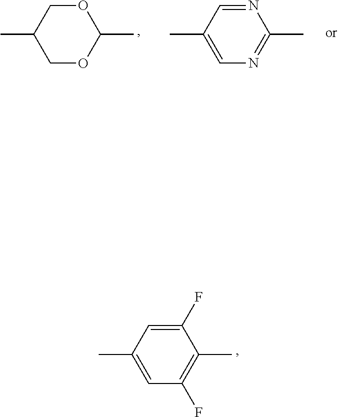

A^{2C} denotes

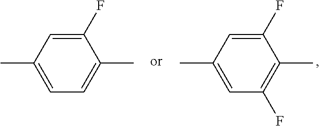

preferably

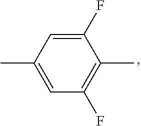

m, n 0, 1 or 2, where (m+n) is 1,
R^{1A}, R^{1B} and R^{1C} independently of each another denote an alkyl radical having 1 to 12 C atoms, preferably 1 to 8, more preferably 1 to 6 and most preferably 1 to 5 C atoms, where, in addition, one or more CH₂ groups in these radicals may in each case be replaced, independently of one another, by —C═C—, —CF₂—O—,

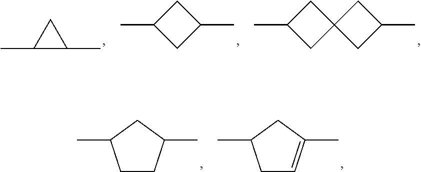

—O—, —S—, —(CO)—O— or —O—(CO)— in such a way that O/S atoms are not linked directly to one another, and in which, in addition, one or more H atoms may be replaced by halogen, or denotes H,

preferably R^{1A}, R^{1B} and R^{1C} independently are a halogenated or unsubstituted alkyl radical having 1 to 10 C atoms, where, in addition, one or more CH₂ groups in these radicals may be replaced by —O— or —CH═CH— in such a way that O atoms are not linked directly.

The percentages are provided under the circumstance that the whole medium makes up 100% by weight of the medium.

The radicals R^{1A}, R^{1B} and R^{1C} in the respective formulae IA, IB and IC-1 to IC-3 and their respective sub-formulae preferably denote alkyl having 1 to 8 carbon atoms, alkoxy having 1 to 8 carbon atoms or alkenyl having 2 to 8 carbon atoms. These alkyl chains are preferably linear or they, preferably in case of R^{1C}, are branched by a single methyl or ethyl substituent, preferably in 2- or 3-position. R^{1A}, R^{1B} and R^{1C} particularly preferably denote a straight-chain alkyl radical having 1 to 7 C atoms or an unbranched alkenyl radical having 2 to 8 C atoms, in particular unbranched alkyl having 1 to 5 C atoms.

Alternative preferred radicals R^{1A}, R^{1B} and R^{1C} are selected from cyclopentyl, 2-fluoroethyl, cyclopropylmethyl, cyclopentylmethyl, cyclopentylmethoxy, cyclobutylmethyl, 2-methylcyclopropyl, 2-methylcyclobutyl, 2-methylbutyl, 2-ethylpentyl and 2-alkyloxyethoxy.

Compounds of the formula IA, IB and IC1 to IC-3 containing branched or substituted end groups R^{1A}, R^{1B} and R^{1C}, respectively, may occasionally be of importance owing to better solubility in the liquid-crystalline base materials. The groups R^{1A}, R^{1B} and R^{1C}, respectively, are preferably straight chain.

The radicals R^{1A}, R^{1B} and R^{1C}, respectively, particularly preferably selected from the moieties:
CH₃
C₂H₅
n-C₃H₇
n-C₄H₉
n-C₅H₁₁
C₂H₅CH(CH₃) CH₂
n-C₆H₁₃
n-C₇H₁₅
n-C₃H₇CH(C₂H₅) CH₂
n-C₈H₁₇
c-C₃H₅
c-C₃H₅CH₂
c-C₄H₇
c-C₃H₇
c-C₅Hg
c-C₅H₉CH₂
CH₂═CH
CH₃CH═CH
CH₂═CH(CH₂)₂
CH₃O
C₂H₅O
n-C₃H₇O
n-C₄H₅O
n-C₅H₁₁O
CH₃OCH₂
C₂H₅OCH₂
CH₃OCH₂CH₂
C₂H₅OCH₂CH₂
c-C₃H₅CH₂O
c-C₅H₉CH₂O

wherein the following abbreviations for the end groups are used:

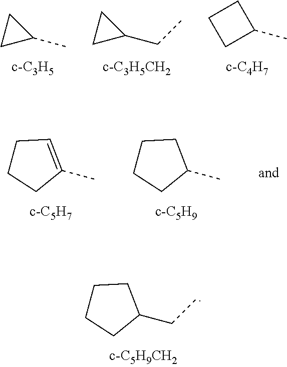

In a preferred embodiment, the media according to the present invention preferably comprise one, two, three or more compounds of formula IA-1

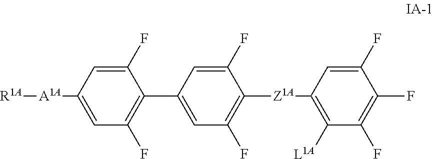

preferably selected from the group of formulae IA-1 to IA-3, preferably of formula IA-1:

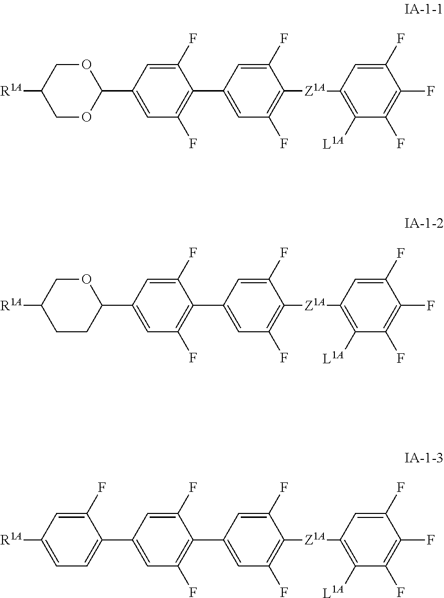

in which the parameters have the respective meanings given above and preferably
Z^{1A} denotes —CF₂—O—.

In a preferred embodiment, the media according to the present invention preferably comprise one, two, three or more compounds of formula IB-1 and/or IB-2, preferably of formula IB-1,

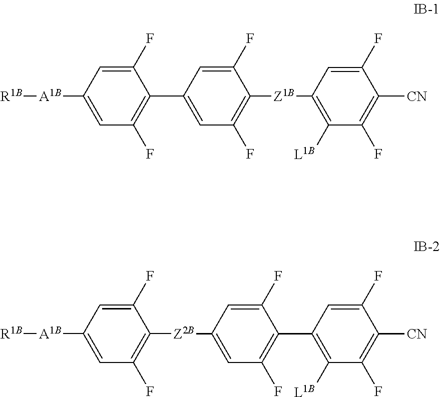

R^{1B} denotes an alkyl radical having 1 to 12 C atoms, preferably 1 to 7, more preferably 1 to 6 and most preferably 1 to 5 C atoms, where, in addition, one or more CH₂ groups in these radicals may in each case be replaced, independently of one another, by —C≡C—, —CF₂—O—, —OCF₂—, —CH═CH—,

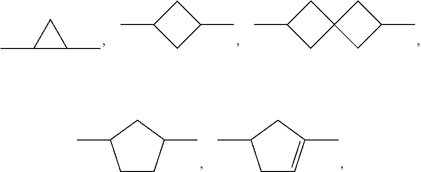

—O—, —S—, —CO—O— or —O—CO—in such a way that O/S atoms are not linked directly to one another, and in which, in addition, one or more H atoms may be replaced by halogen, or denotes H,
preferably R^{1B} is a halogenated or unsubstituted alkyl radical having 1 to 12 C atoms, where, in addition, one or more CH₂ groups in these radicals may in each case be replaced, independently of one another, by —C═C— or —CH═CH—,
A^{1B} denotes

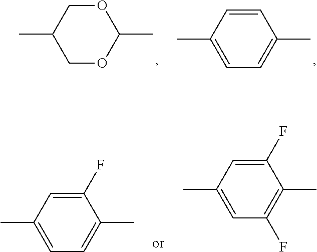

preferably

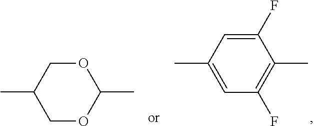

and
Z^{1B}, Z^{2B} independently denote —(CO)—O— or —CF₂—O—, preferably selected from the group of the following formulae, formulae IB-1-1 to IB-2-3:

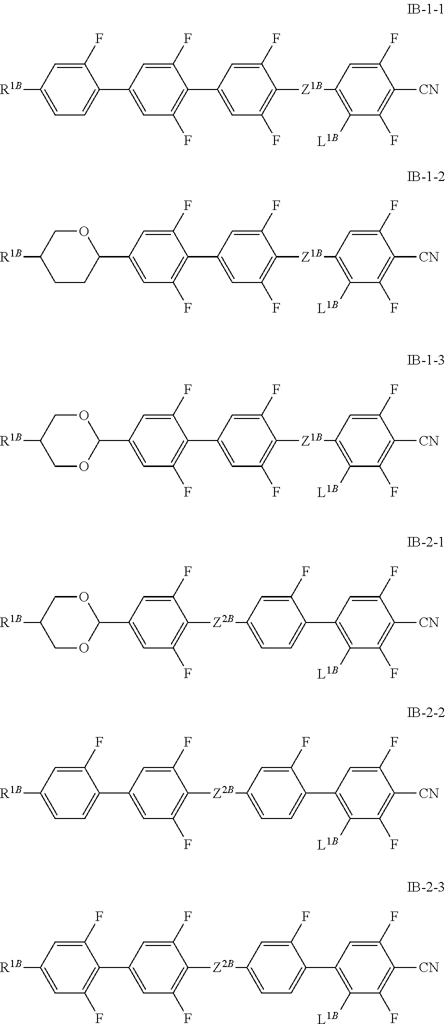

in which the parameters have the respective meanings given above and, in particular, in formula IB-1-1 to IB-1-3,
Z^{1B} preferably denotes —CF₂—O—and, in particular, in formula IB-2-1 and IB-2-2,
Z^{2B} denotes preferably —CF₂—O—; and, in particular, in formula IB-2-3,
Z^{2B} denotes preferably —C(O)O—.

In a preferred embodiment, the media according to the present invention preferably comprise one, two, three or more compounds selected of formulae IC-1-1 to IC-3-5:

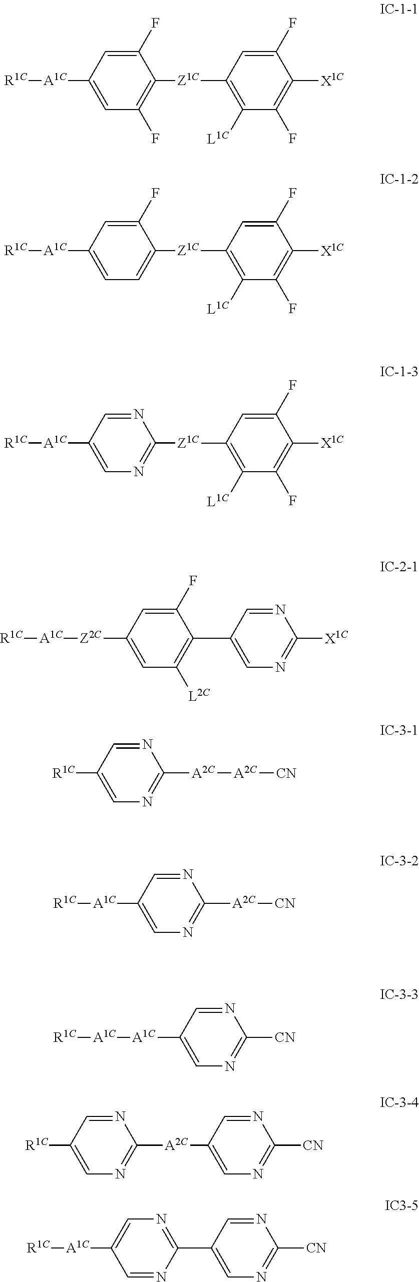

wherein A^{1C} and A^{2C} are defined as above, preferably selected from the group of formulae IC-1-1-1 to IC-3-5-2, preferably selected from the group of formulae IC-1-1-1, IC-1-1-2, IC-1-1-3, IC-1-1-4, IC-3-1-1 and IC-3-2-1:

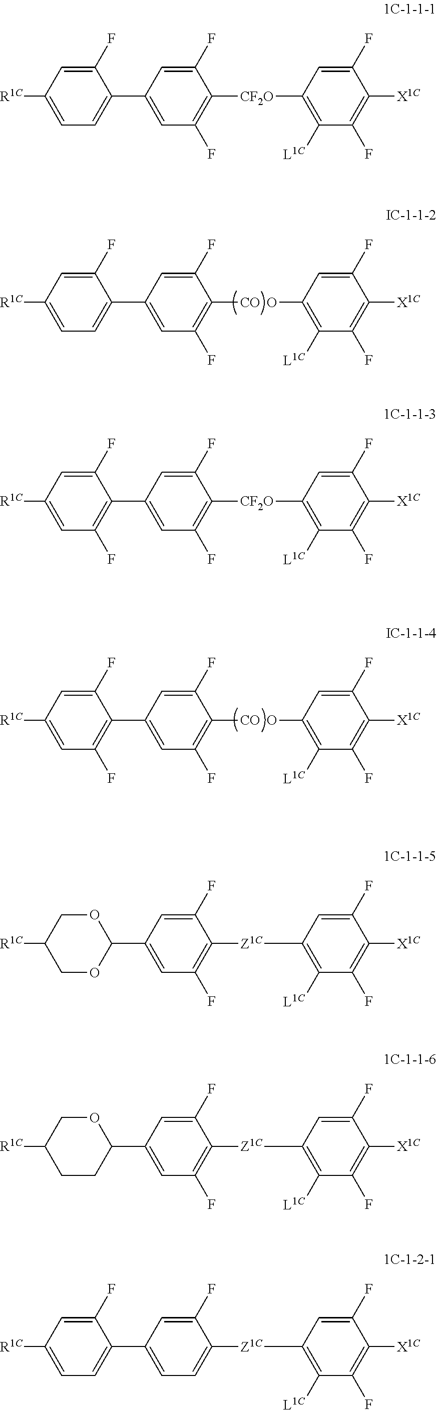

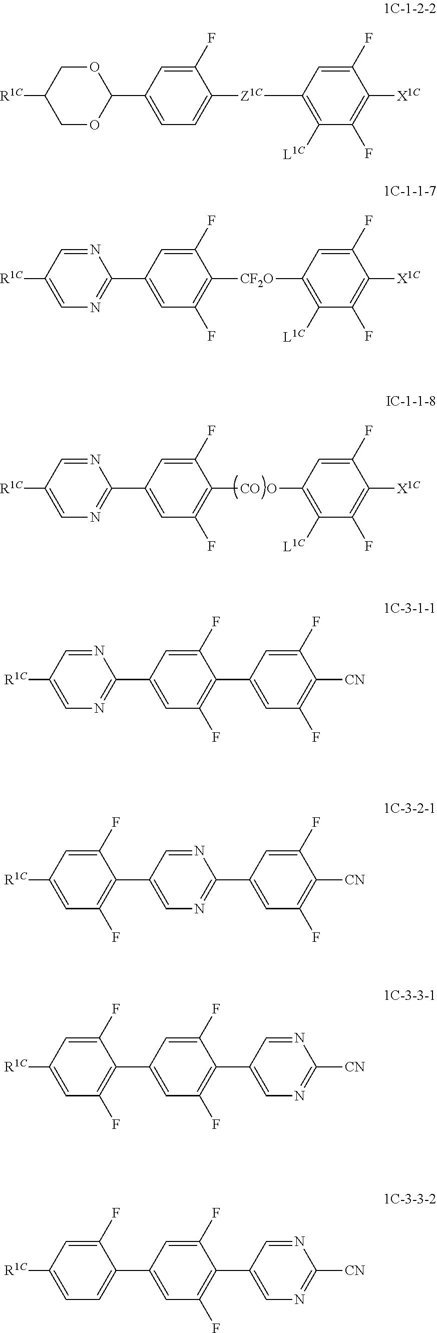

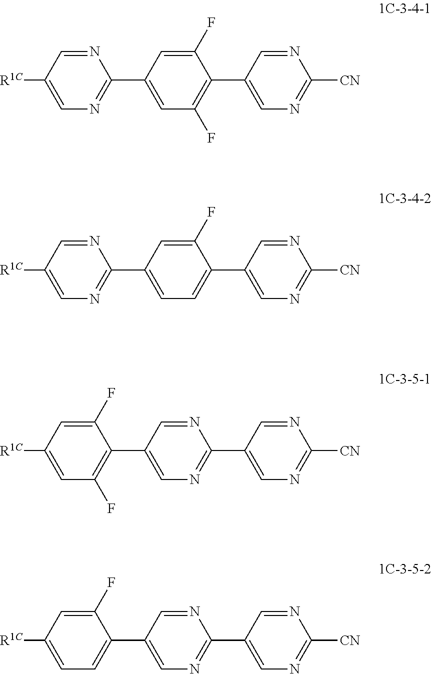

in which the parameters have the respective meanings given above and preferably
L^{1C} denotes H,
Z^{1C} denotes —CF₂—O— or —(CO)—O—, and
X^{1C} denotes —CN or F, preferably —CN.

Particularly preferred compounds of the formula IC-1-1 to IC-1-4 used in the media are the compounds of the formulae below:

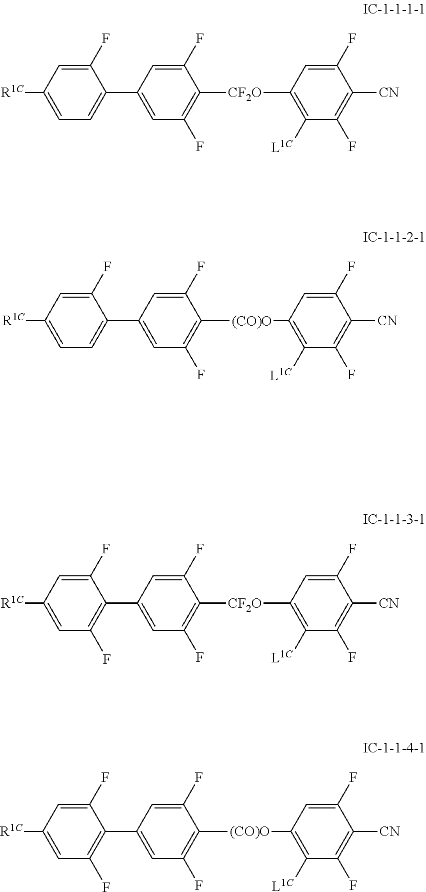

wherein the parameters are defined as above, preferably L^{1C} is H.

In a preferred embodiment of the present invention the media comprise up to 100% of one or more compounds, preferably of three, four, five, six or more, compounds selected from group 1 of compounds, the group of compounds of formulae IA, IB and IC-1/-2/-3. In this embodiment the media preferably predominantly consist of, more preferably they essentially consist of, and most preferably, they virtually completely consist of these compounds.

For the present invention, the following definitions apply in connection with the specification of the constituents of the compositions, unless indicated otherwise in individual cases:
“comprise”: the concentration of the constituents in question in the composition is preferably 5% or more, particularly preferably 10% or more, very particularly preferably 20% or more,
“predominantly consist of”: the concentration of the constituents in question in the composition is preferably 50% or more, particularly preferably 55% or more and very particularly preferably 60% or more,
“essentially consist of”: the concentration of the constituents in question in the composition is preferably 80% or more, particularly preferably 90% or more and very particularly preferably 95% or more, and
“virtually completely consist of”: the concentration of the constituents in question in the composition is preferably 98% or more, particularly preferably 99% or more and very particularly preferably 100.0%.

Preferably the media according to the present application fulfil one or more of the following conditions. They preferably comprise:
20% or more of compounds of formula IA, more preferably 25%, more preferably 27% or more and most preferably 32% by weight or more of compounds of formula IA,
17% or more of compounds of formula IB, more preferably 20% or more, more preferably 22% or more and most preferably 25% by weight or more of compounds of formula IB,
20% or more, preferably 25% or more of compounds selected of formula IC-1, IC-2 and IC-3, more preferably 28%, more preferably 32% or more and most preferably 34% by weight or more,
optionally 2% or more of compounds of formula ID (ID-1, ID-2, ID-3, ID-4), more preferably 5%, more preferably 10% or more and most preferably 15% by weight or more of compounds of formula ID,
one, two, three or more, preferably three or more, compounds of the formula IA-1-1, preferably of formula DUUQU-n-F, most preferably selected from the group of the compounds DUUQU-2-F, DUUQU-3-F, DUUQU-4-F and DUUQU-5-F and DUUQU-6-F,
one, two, three or more, preferably three or more, compounds of the formula IB-1, preferably of formulae GUUQU-n-N and/or DUUQU-n-N, most preferably selected from the group of the compounds GUUQU-2-N, GUUQU-3-N, GUUQU-4-N, GUUQU-5-N, GUUQU-6-N, GUUQU-7-N, DUUQU-2-N, DUUQU-3-N, DUUQU-4-N, DUUQU-5-N and DUUQU-6-N,
one, two, three or more compounds of the formula IA-1-3, preferably of formula GUUQU-n-F, more preferred selected from the group of the compounds GUUQU-3-F, GUUQU-4-F and GUUQU-5-F,
one, two, three or more compounds of the formula IB-1-3, preferably of formula DUUQU-n-N, more preferred selected from the group of the compounds DUUQU-3-N, DUUQU-4-N and DUUQU-5-N,
one, two, three or more compounds of the formula IC-1-1, preferably of formula MUZU-n-N or MUQU-n-N, more preferred selected from the group of the compounds MUZU-2-N, MUZU-3-N, MUZU-4-N and MUZU-5-N,
one, two, three or more compounds of the formula IC-3, preferably selected from the formulae MUU-n-N or UMU-n-N, more preferably selected from the group of the compounds MUU-3-N, MUU-4-N, MUU-5-F, UMU-3-N, UMU-4-N and UMU-5-N,
one, two, three or more compounds of the formula IC-1-1, preferably selected from the formulae GUZU-n-N or GUQU-n-N, more preferably selected from the group of the compounds GUZU-3-N, GUZU-4-N, GUZU-5-F, GUQU-3-N, GUQU-4-N and GUQU-5-N,

and/or
one, two, three or more compounds of the group of formulae IC-1-1-3 and IC-1-1-4, preferably of formulae UUZU-n-N and/or UUQU-n-N, most preferably selected from the group of the compounds UUZU-2-N, UUZU-3-N, UUZU-4-N, UUZU-5-N, UUQU-2-N, UUQU-3-N and UUQU-4-N,

wherein n is 1, 2, 3, 4, 5, 6 or 7.

In another preferred embodiment of the present invention said compounds of formulae IA, IB and IC-1/-2/-3 are a first group of compounds, group 1, of compounds. In this embodiment the concentration of the compounds of this group 1 of compounds preferably is in the range from 70% or more, preferably 80% or more, more preferably 90% or more to 100% or less.

In addition to the compounds of formulae IA, IB and IC-1/-2/-3 the media according to the invention optionally, preferably obligatory, comprise one, two, three or more compounds selected from formula ID-1 to ID-4,

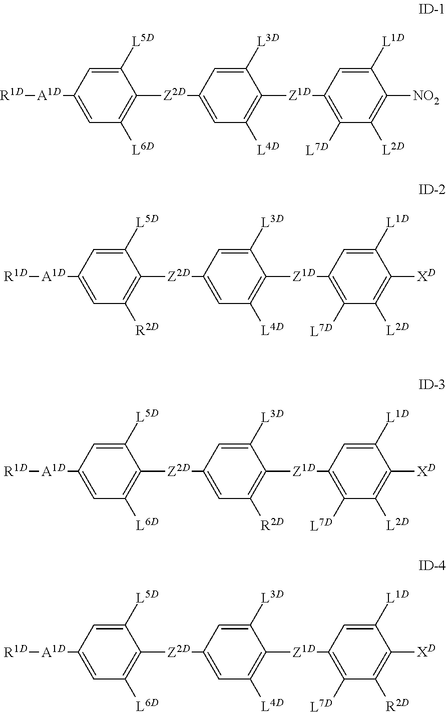

X^{D} denotes CN, F, CF₃, —OCF₃, NCS, SF₅ or O—CF═CF₂, preferably —CN, F, —CF₃, —OCF₃, —CI or —NCS, most preferably F or CN,
L^{1D}, L^{2D}, L^{3D}, L^{4D}, L^{5D}, L^{6D} and L^{7D}, independently denote F, H, alkyl, alkoxy or alkoxyalkyl, each with 1 to 7 C atoms, preferably H, F, CH₃, OCH₃, OCH₂CH₃, CH₂OCH₃, CH₂OCH₂CH₃, CH₂CH₂OCH₃, CH₂CH₂OCH₂CH₃ or CH₂CH₂CH₂OCH₃,
Z^{1D} and Z^{2D} independently of one another denote —(CO)—O—, —CF₂—O—, a single bond, and preferably both —(CO)—O—,
R^{1D} denotes an alkyl radical having 1 to 12 C atoms, preferably 1 to 7, more preferably 1 to 6 and most preferably 1 to 5 C atoms, where, in addition, one or more CH₂ groups in these radicals may in each case be replaced, independently of one another, by —C≡C—, —CF₂—O—, —OCF₂—, —CH═CH—,

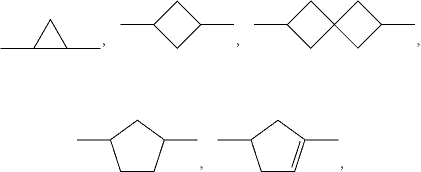

or —O—(CO)— in such a way that O/S atoms are not linked directly to one another, and in which, in addition, one or more H atoms may be replaced by halogen, or denotes H,
preferably R^{1D} is a halogenated or unsubstituted alkyl radical having 1 to 12 C atoms, where, in addition, one or more CH₂ groups in these radicals may in each case be replaced, independently of one another, by —C≡C— or —CH═CH—,
R^{2D} denotes alkyl, alkoxy or alkoxyalkyl, each with 1 to 7 C atoms, preferably CH₃, OCH₃, OCH₂CH₃, CH₂OCH₃, CH₂OCH₂CH₃, CH₂CH₂OCH₃, CH₂CH₂OCH₂CH₃ or CH₂CH₂CH₂OCH₃,
A^{1D} denotes a single bond,

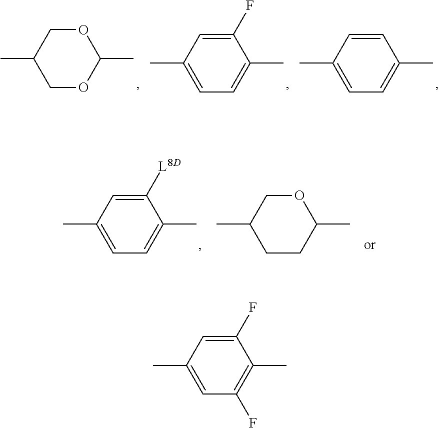

preferably a single bond,

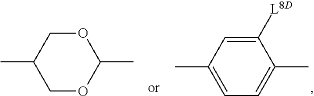

wherein
L^{8D} denotes alkyl, alkoxy or alkoxyalkyl, each with 1 to 7 C atoms, preferably CH₃, OCH₃, OCH₂CH₃, CH₂OCH₃, CH₂OCH₂CH₃, CH₂CH₂OCH₃, CH₂CH₂OCH₂CH₃ or CH₂CH₂CH₂OCH₃,

preferably it comprises one or more of formulae ID-1-1 to ID-3-1:

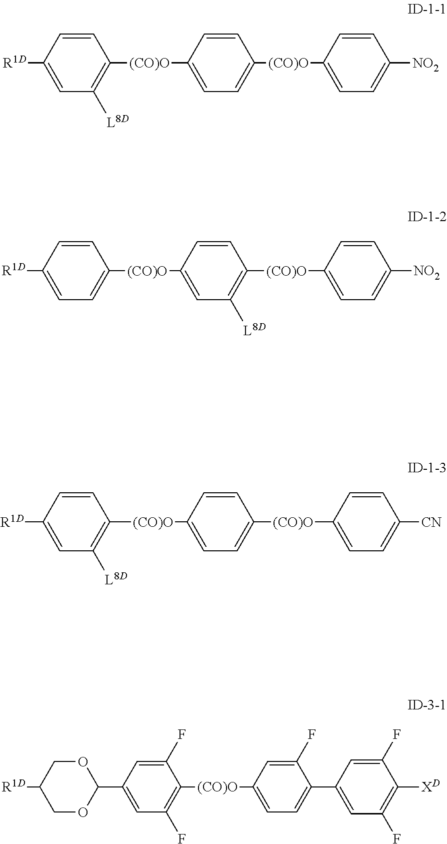

wherein the variable groups R^{1D} and L^{8D} are defined as above.

Corresponding starting materials can generally readily be prepared by the person skilled in the art by synthetic methods known from the literature or are commercially available. The reaction methods and reagents used are in principle known from the literature.

In the present disclosure, the 2,5-disubstituted dioxane ring of the formula

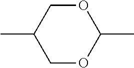

preferably denotes a 2,5-trans-configured dioxane ring, i.e., the substituents R are preferably both in the equatorial position in the preferred chair conformation. The 2,5-disubstituted tetrahydropyran of the formula

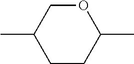

likewise preferably denotes a 2,5-trans-configured tetrahydropyran ring, i.e., the substituents are preferably both in the equatorial position in the preferred chair conformation.

The liquid crystalline medium used according to the invention has a broad temperature range of the ferroelectric nematic phase. It exhibits the ferroelectric nematic phase ranges at 20° and above and below (ambient temperature). It covers the technically most interesting range from at least 10 to 50° C. and significantly beyond to lower and/or higher temperatures. So it is highly suitable for all kind of household or industry use, and with some limitations even outdoors. The medium exhibits a ferroelectric nematic phase at least over a temperature range of 20 Kelvin or more, more preferably over 30 K or more, and most preferably over a range of 40 K or more. Preferably the ferroelectric phase is obtained independently of the previous temperature and phase (enantiotropic ferroelectric nematic phase). The achievable combinations of temperature range of the ferroelectric nematic phase, clearing point, low-temperature stability (LTS), (relative) dielectric permittivity, dielectric anisotropy and optical anisotropy containing the compounds of formulae IA, IB and IC-1/-2/-3 are far superior to previous materials of such kind from the prior art. Previously only single compound materials were available with limited choice, which have a limited ferroelectric nematic phase range.

The liquid crystal media used according to the invention preferably exhibit a temperature range of the ferroelectric nematic phase which is 20 degrees wide or more, preferably it extends over a range of 40 degrees or more, more preferably of 60 degrees or more.

Preferably the liquid crystal media used according to the invention exhibit the ferroelectric nematic phase from 10° C. to 30° C., more preferably from 10° C. to 40° C., more preferably from 10° C. to 50° C., more preferably from 0° C. to 50° C. and, most preferably, from −10° C. to 50° C.

In another preferred embodiment the liquid crystal media used according to the invention preferably exhibit the ferroelectric nematic phase from 10° C. to 40° C., more preferably from 10° C. to 50° C., more preferably from 10° C. to 60° C. and, most preferably, from 10° C. to 70° C.

The liquid crystal media used according to the invention exhibit outstanding dielectric properties. Due to their outstanding properties, e.g. their extremely high dielectric permittivity ε and their insulating property, the media can perform in electro-mechanic devices, including electric generators (i.e. energy harvesting devices) and actuators.

Preferably the media according to the invention have values of εᵣ of 15000 or more, even more preferably 30000 or more, and more preferably 35000 or more (at 20° C. and 10 Hz).

These advantageous dielectric properties are predominantly achieved at temperatures at which the media are in the ferroelectric nematic phase. The dielectric characteristics may occasionally show a hysteresis behavior, particularly under varying temperature, and in that case the values obtained at a certain temperature may depend on the history of the material, i.e. whether the material is being heated up or cooled down.

The liquid crystal media according to the invention preferably comprise 2 to 40, particularly preferably 4 to 20, compounds as further constituents besides one or more compounds according to the invention. In particular, these media may comprise 1 to 25 components besides one or more compounds according to the invention. These further constituents are preferably selected from ferroelectric nematic or nematogenic (monotropic or isotropic) substances,

Prior art ferroelectric substances and similar compounds with high dielectric permittivity for combination with the current substances are selected from e.g. the following structures:

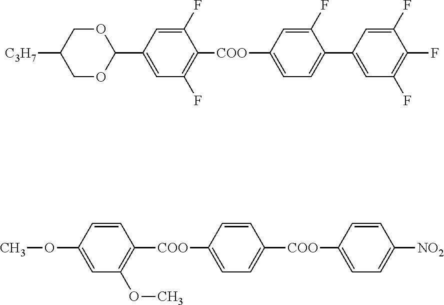

The media used for the invention preferably comprise 1% to 100%, more preferably 10% to 100% and, particularly preferably, 50% to 100%, of the compounds of formulae IA and/or IB and/or IC-1/IC-2/IC-3 preferably used according to the invention.

The expression “alkyl” encompasses unbranched and branched alkyl groups having 1 to 12 carbon atoms, preferably 1 to 10 carbon atoms, in particular and preferably the unbranched groups methyl, ethyl, n-propyl, n-butyl, n-pentyl, n-hexyl and n-heptyl and further, alternatively, the groups n-butyl, n-pentyl, n-hexyl and n-heptyl substituted by one methyl, ethyl or propyl. Groups having 1-5 carbon atoms are generally preferred.

The expression “alkenyl” encompasses unbranched and branched alkenyl groups having up to 12 carbon atoms, in particular the unbranched groups. Particularly preferred alkenyl groups are C₂-C₇-1E-alkenyl, C₄-C₇-3E-alkenyl, C₅-C₇-4-alkenyl, C₆-C₇-5-alkenyl and C₇-6-alkenyl, in particular C₂-C₇-1E-alkenyl, C₄-C₇-3E-alkenyl and C₅-C₇-4-alkenyl. Examples of preferred alkenyl groups are vinyl, 1E-propenyl, 1E-butenyl, 1E-pentenyl, 1E-hexenyl, 1E-heptenyl, 3-butenyl, 3E-pentenyl, 3E-hexenyl, 3E-heptenyl, 4-pentenyl, 4Z-hexenyl, 4E-hexenyl, 4Z-heptenyl, 5-hexenyl, 6-heptenyl and the like. Groups having 2 to 5 carbon atoms are generally preferred.

The expression “halogenated alkyl radical” preferably encompasses mono—or polyfluorinated and/or —chlorinated radicals. Perhalogenated radicals are included. Particular preference is given to fluorinated alkyl radicals, in particular CF₃, CH₂CF₃, CH₂CHF₂, CHF₂, CH₂F, CHFCF₃ and CF₂CHFCF₃. The expression “halogenated alkenyl radical” and related expressions are explained correspondingly.

The following examples explain the invention without intending to restrict it. The person skilled in the art will be able to glean from the examples working details that are not given in detail in the general description, generalise them in accordance with general expert knowledge and apply them to a specific problem.

Above and below, percentage data denote percent by weight. All temperature values indicated in the present application, such as, for example, the melting point T(C,N), the smectic (Sm) to nematic (N) phase transition T(S,N) and the clearing point T(N,I), resp. T(N_{f},I), are indicated in degrees Celsius (° C.) and all temperature differences are correspondingly indicated in differential degrees (° or degrees), unless explicitly indicated otherwise. Furthermore, C=crystalline state, N=nematic phase, N_{f}=ferroelectric nematic phase, Sm=smectic phase (more especially SmA, SmB, etc.), Tg=glass-transition temperature and I=isotropic phase. The data between these symbols represent the transition temperatures. Δn denotes optical anisotropy (589 nm, 20° C.), As the dielectric anisotropy (1 kHz, 20° C.).

The physical, physicochemical and electro-optical parameters are determined by generally known methods, as described, inter alia, in the brochure “Merck Liquid Crystals-Licristal®-Physical Properties of Liquid Crystals-Description of the Measurement Methods”, 1998, Merck KGaA, Darmstadt.

The occurrence of the ferroelectric nematic phase of the materials is identified using differential scanning calorimetry (DSC), via observation of the textures under a polarising microscope equipped with a hot-stage for controlled cooling resp. heating and additionally confirmed by temperature dependent determination of the dielectric properties. Transition temperatures are predominantly determined by detection of the optical behaviour under a polarising microscope.

The dielectric anisotropy As of the individual substances is determined at 20° C. and 1 kHz. To this end, 5 to 10% by weight of the substance to be investigated are measured dissolved in the dielectrically positive mixture ZLI-4792 (Merck KGaA), and the measurement value is extrapolated to a concentration of 100%. The optical anisotropy An is determined at 20° C. and a wavelength of 589.3 nm by linear extrapolation.

The relative dielectric permittivity (εᵣ) of the materials, especially in the ferroelectric nematic phase is directly determined by measuring the capacitance of at least one test cell containing the compound and having cell thickness of 250 μm with homeotropic and with homogeneous alignment, respectively. Temperature is controlled by a Novocontrol Novocool system set to temperature gradients of +/−1 K/min; +/−2 K/min; +/−5 K/min; +/−10 K/min applied to the sample cell. Capacitance is measured by a Novocontrol alpha-N analyzer at a frequency of 1 kHz or 10 Hz with a typical voltage <50 mV down to 0.1 mV in order make sure to be below the threshold of the investigated compound. Measurements are performed both upon heating and upon cooling of the sample(s).

In the present application, unless explicitly indicated otherwise, the plural form of a term denotes both the singular form and the plural form, and vice versa. Further combinations of the embodiments and variants of the invention in accordance with the description also arise from the appended claims or from combinations of a plurality of these claims.

### EXAMPLES

The present invention is described in detail by the following non-restrictive examples and figures.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

From the foregoing description, one skilled in the art can easily ascertain the essential characteristics of this invention and, without departing from the spirit and scope thereof, can make various changes and modifications of the invention to adapt it to various usages and conditions.

This applies both to the media as compositions with their constituents, which can be groups of compounds as well as individual compounds, and also to the groups of compounds with their respective constituents, the compounds. Only in relation to the concentration of an individual compound relative to the medium as a whole does the term comprise mean: the concentration of the compound or compounds in question is preferably 1% or more, particularly preferably 2% or more, very particularly preferably 4% or more.

For the present invention

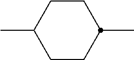

denotes trans-1,4-cyclohexylene,

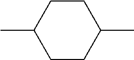

denotes a mixture of both cis- and trans-1,4-cyclohexylene and

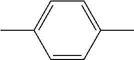

denotes 1,4-phenylene.

For the present invention, the expression “dielectrically positive compounds” means compounds having a Δε of >1.5, the expression “dielectrically neutral compounds” means compounds having −1.5≤Δε≤1.5 and the expression “dielectrically negative compounds” means compounds having Δε<−1.5. The dielectric anisotropy of the compounds is determined here by dissolving 10% of the compounds in a liquid-crystalline host and determining the capacitance of the resultant mixture in each case in at least one test cell having a cell thickness of 20 μm with homeotropic and with homogeneous surface alignment at 1 KHz. The measurement voltage is typically 0.5 V to 1.0 V, but is always lower than the capacitive threshold of the respective liquid-crystal mixture (material) investigated.

The liquid-crystal media according to the invention may, if necessary, also comprise further additives, such as, for example, stabilisers in the usual amounts. The amount of these additives employed is preferably in total 0% or more to 10% or less, based on the amount of the entire mixture, particularly preferably 0.1% or more to 6% or less. The concentration of the individual compounds employed is preferably 0.1% or more to 3% or less. The concentration of these and similar additives is generally not taken into account when specifying the concentrations and concentration ranges of the liquid-crystal compounds in the liquid-crystal media.

For the purposes of the present invention, all concentrations are, unless explicitly noted otherwise, indicated in percent by weight and relate to the corresponding mixture as a whole or mixture constituents, again a whole, unless explicitly indicated otherwise. In this context the term “the mixture” describes the liquid crystalline medium.

The following symbols are used, unless explicitly indicated otherwise:
T (N,I) resp. T(N_{f},I) (or clp.) clearing point [° C.],

Dielectric properties at 1 KHz and preferably at 20° C. or at the respective temperature specified:
Δε dielectric anisotropy and especially for the screening data of single compounds.

And, in particular for the data from the screening of the respective compounds in the nematic host mixture ZLI-4792:
nₑ extraordinary refractive index measured at 20° C. and 589 nm,
nₒ ordinary refractive index measured at 20° C. and 589 nm and
Δn optical anisotropy measured at 20° C. and 589 nm.

The following examples explain the present invention without limiting it. However, they show the person skilled in the art preferred mixture concepts with compounds preferably to be employed and the respective concentrations thereof and combinations thereof with one another. In addition, the examples illustrate the properties and property combinations that are accessible.

Definitions of structural elements by abbreviations for use in acronyms for chemical compounds:

TABLE A
Ring elements

| | |
|---|---|
| C | 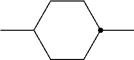 |
| D | 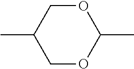 |
| DI | 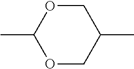 |
| A | 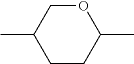 |
| AI | 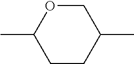 |
| P | 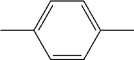 |
| G | 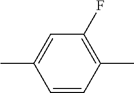 |
| GI | 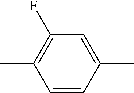 |
| U | 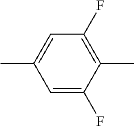 |
| UI | 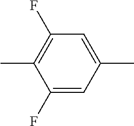 |
| Y | 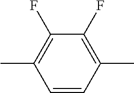 |
| M | 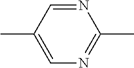 |
| P(F, Cl)Y | 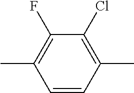 |
| P(Cl,F)Y | 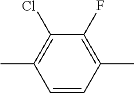 |
| np | 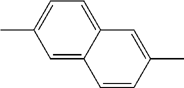 |
| L | 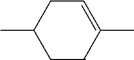 |
| LI | 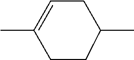 |
| F | 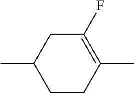 |
| FI | 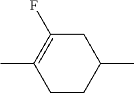 |

TABLE B
Bridging units

| | | | |
|---|---|---|---|
| E | —CH₂—CH₂— | | |
| V | —CH═CH— | | |
| T | —C≡C— | | |
| W | —CF₂—CF₂— | | |
| B | —CF═CF— | | |
| Z | —CO—O— | ZI | —O—CO— |
| X | —CF═CH— | XI | —CH═CF— |
| O | —CH₂—O— | OI | —O—CH₂— |
| Q | —CF₂—O— | QI | —O—CF₂— |

TABLE C
End groups

| On the left individually or in combination | | On the right individually or in combination | |
|---|---|---|---|
| -n- | CₙH₂ₙ₊₁— | -n | —CₙH₂ₙ₊₁ |
| -nO— | CₙH₂ₙ₊₁—O— | —On | —O—CₙH₂ₙ₊₁ |
| —V— | CH₂═CH— | —V | —CH═CH₂ |
| -nV— | CₙH₂ₙ₊₁—CH═CH— | -nV | —CₙH₂ₙ—CH═CH₂ |
| —Vn- | CH₂═CH—CₙH₂ₙ— | —Vn | —CH═CH—CₙH₂ₙ₊₁ |
| -nVm- | CₙH₂ₙ₊₁—CH═CH—CₘH₂ₘ— | -nVm | —CₙH₂ₙ—CH═CH—CₘH₂ₘ₊₁ |
| —N— | N≡C— | —N | —C≡N |
| —S— | S═C═N— | —S | —N═C═S |
| —F— | F— | —F | —F |
| —CL— | Cl— | —CL | —Cl |
| —M— | CFH₂— | —M | —CFH₂ |
| —D— | CF₂H— | —D | —CF₂H |
| —T— | CF₃— | —T | —CF₃ |
| —MO— | CFH₂O— | —OM | —OCFH₂ |
| —DO— | CF₂HO— | —OD | —OCF₂H |
| —TO— | CF₃O— | —OT | —OCF₃ |
| —A— | H—C≡C— | —A | —C≡C—H |
| -nA— | CₙH₂ₙ₊₁—C≡C— | —An | —C≡C—CₙH₂ₙ₊₁ |
| —NA— | N≡C—C≡C— | —AN | —C≡C—C≡N |

| | |
|---|---|
| On the left only in combination | On the right only in combination |

| | | | |
|---|---|---|---|
| - . . . n . . . - | —CₙH₂ₙ— | - . . . n . . . | —CₙH₂ₙ— |
| - . . . M . . . - | —CFH— | - . . . M . . . | —CFH— |
| - . . . D . . . - | —CF₂— | - . . . D . . . | —CF₂— |
| - . . . V . . . - | —CH═CH— | - . . . V . . . | —CH═CH— |
| - . . . Z . . . - | —CO—O— | - . . . Z . . . | —CO—O— |
| - . . . ZI . . . - | —O—CO— | - . . . ZI . . . | —O—CO— |
| - . . . K . . . - | —CO— | - . . . K . . . | —CO— |
| - . . . W . . . - | —CF═CF— | - . . . W . . . | —CF═CF— |

in which n and m are each integers, and the three dots “ . . . ” are place-holders for other abbreviations from this table.

Besides the compounds of formulae IA, IB and IC-1/-2/-3 the mixtures according to the invention preferably comprise one or more compounds of the compounds mentioned below.

The following abbreviations are used:
(n, m, k and l are, independently of one another, each an integer, preferably 1 to 9 preferably 1 to 7, k and I possibly may be also 0 and preferably are 0 to 4, more preferably 0 or 2 and most preferably 2, n preferably is 1, 2, 3, 4 or 5, in the combination “-nO-” it preferably is 1, 2, 3 or 4, preferably 2 or 4, m preferably is 1, 2, 3, 4 or 5, in the combination “-Om” it preferably is 1, 2, 3 or 4, more preferably 2 or 4. The combination “-IVm” preferably is “2V1”.)

For the present invention and in the following examples, the structures of the liquid-crystal compounds are indicated by means of acronyms, with the transformation into chemical formulae taking place in accordance with Tables A to C above. All radicals CₙH₂ₙ₊₁, CₘH₂ₘ₊₁ and CₗH₂ₗ₊₁ or CₙH₂ₙ, CₘH₂ₘ and CₗH₂ₗ are straight-chain alkyl radicals or alkylene radicals, in each case having n, m and I C atoms respectively. Preferably n, m and I are independently of each other 1, 2, 3, 4, 5, 6, or 7. Table A shows the codes for the ring elements of the nuclei of the compound, Table B lists the bridging units, and Table C lists the meanings of the symbols for the left—and right-hand end groups of the molecules. The acronyms are composed of the codes for the ring elements with optional linking groups, followed by a first hyphen and the codes for the left-hand end group, and a second hyphen and the codes for the right-hand end group. Table D shows illustrative structures of compounds together with their respective abbreviations.

TABLE D
Exemplary, preferred compounds of formula IA

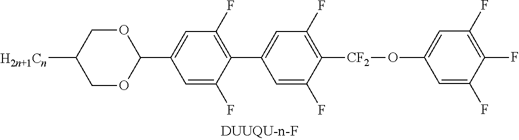

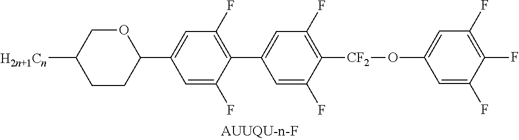

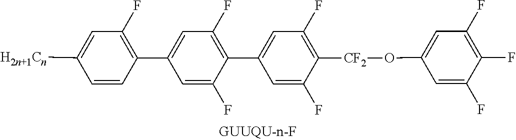

Exemplary, preferred compounds of formula IB

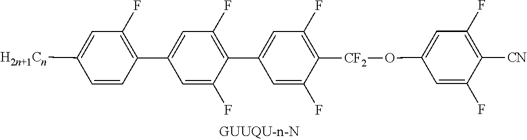

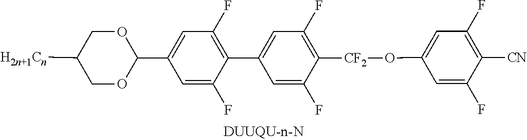

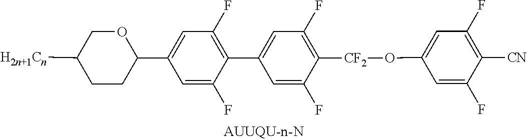

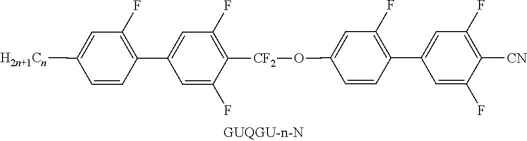

Exemplary, preferred compounds of formula IC-1

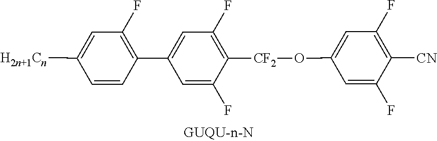

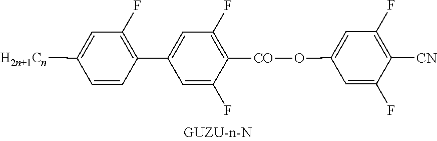

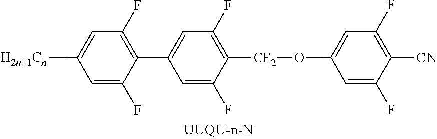

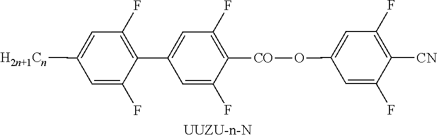

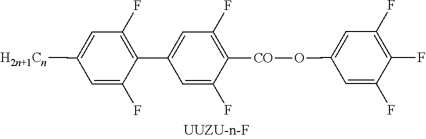

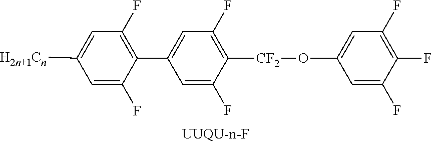

Exemplary, preferred compounds of formula IC-3

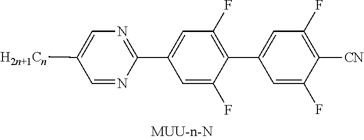

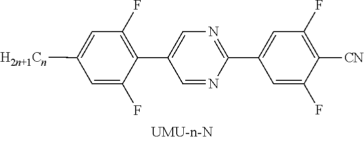

Further compounds optionally used

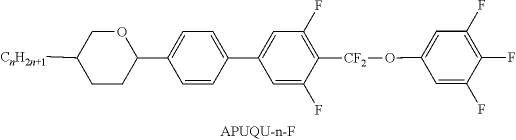

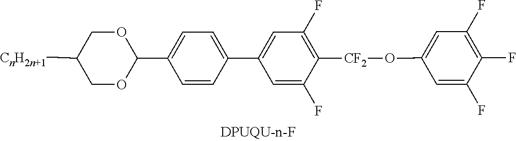

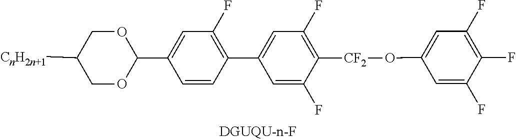

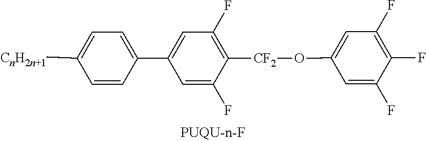

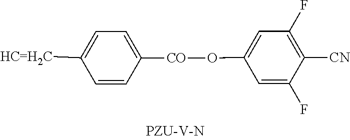

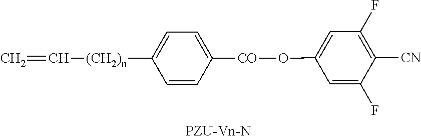

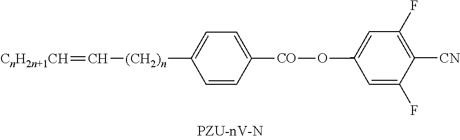

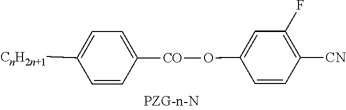

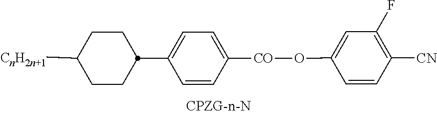

wherein n is 0, 1, 2, 3, 4, 5, 6, 7, etc., preferably 0, 1, 2, 3, 4 or 5.

### MIXTURE EXAMPLES

In the following exemplary mixtures are disclosed. The preparation of the compounds is made analogous to those of same or similar structure in earlier publications. The preparation of mixtures is made in a conventional way by combining the required materials and homogenizing them at a suitably high temperature.

### Mixture Example 1

The following mixture (M-1) is prepared.

Mixture M-1

| Composition | | | |
|---|---|---|---|
| Compound | | Concentration | |
| No. | Abbreviation | /% by weight | Physical properties |
| 1 | DUUQU-3-F | 18.0 | T(N, I) = 97° C. |
| 2 | DUUQU-4-F | 18.0 | T(FerroN) c = 52° C. |
| 3 | DUUQU-5-F | 7.0 | ε(20° C., 1 kHz) c = 3960 |
| 4 | GUUQU-3-N | 10.0 | ε(20° C., 10 Hz) c = 42200 |
| 5 | GUUQU-4-N | 13.0 | |
| 6 | GUUQU-5-N | 4.0 | |
| 7 | GUZU-4-N | 15.0 | |
| 8 | GUQU-4-N | 15.0 | |
| Σ | | 100.0 | |

c) value upon cooling,

### Mixture Example 2

The following mixture (M-2) is prepared.

Mixture M-2

| Composition | | | |
|---|---|---|---|
| Compound | | Concentration | |
| No. | Abbreviation | /% by weight | Physical properties |
| 1 | DUUQU-3-F | 16.0 | T(N, I) = 97° C. |
| 2 | DUUQU-4-F | 16.0 | T(FerroN) c = 49° C. |
| 3 | DUUQU-5-F | 7.0 | ε(20° C., 1 kHz) c = 3220 |
| 4 | GUUQU-3-N | 10.0 | ε(20° C., 10 Hz) c = 42200 |
| 5 | GUUQU-4-N | 13.0 | |
| 6 | GUUQU-5-N | 4.0 | |
| 7 | GUZU-4-N | 13.0 | |
| 8 | GUZU-5-N | 8.0 | |
| | GUQU-4-N | 13.0 | |
| Σ | | 100.0 | |

c) value upon cooling,

### Mixture Example 3

The following mixture (M-3) is prepared.

Mixture M-3

| Composition | | | |
|---|---|---|---|
| Compound | | Concentration | |
| No. | Abbreviation | /% by weight | Physical properties |
| 1 | DUUQU-3-F | 15.0 | T(N, I) = 96° C. |
| 2 | DUUQU-4-F | 14.0 | T(FerroN) c = 41° C. |
| 3 | DUUQU-5-F | 6.0 | no = t.b.d. |
| 4 | GUUQU-3-N | 9.0 | ne = t.b.d. |
| 5 | GUUQU-4-N | 12.0 | ε(20° C., 1 kHz) c = 4060 |
| 6 | GUUQU-5-N | 4.0 | ε(20° C., 10 Hz) c = 42600 |
| 7 | GUZU-4-N | 15.0 | |
| 8 | GUZU-5-N | 10.0 | |
| | GUQU-4-N | 15.0 | |
| Σ | | 100.0 | |

c) value upon cooling,

These is the highest value of the relative dielectric permittivity εᵣ for any physical matter known to the authors so far.

### Mixture Example 4

The following mixture (M-4) is prepared.

Mixture M-4

| Composition | | | |
|---|---|---|---|
| Compound | | Concentration | |
| No. | Abbreviation | /% by weight | Physical properties |
| 1 | DUUQU-3-F | 14.0 | T(N, I) = 91° C. |
| 2 | DUUQU-4-F | 13.0 | T(FerroN) c = 33° C. |
| 3 | DUUQU-5-F | 5.0 | ε(20° C., 1 kHz) c = 5270 |
| 4 | GUUQU-3-N | 8.0 | ε(20° C., 10 Hz) c = 40500 |
| 5 | GUUQU-4-N | 11.0 | |
| 6 | GUUQU-5-N | 3.0 | |
| 7 | GUZU-4-N | 17.0 | |
| 8 | GUZU-5-N | 12.0 | |
| | GUQU-4-N | 17.0 | |
| Σ | | 100.0 | |

c) value upon cooling,

### Mixture Example 5

The following mixture (M-5) is prepared.

Mixture M-5

| Composition | | | |
|---|---|---|---|
| Compound | | Concentration | |
| No. | Abbreviation | /% by weight | Physical properties |
| 1 | DUUQU-3-F | 13.0 | T(N, I) = 88° C. |
| 2 | DUUQU-4-F | 11.0 | T(FerroN) c = 25° C. |
| 3 | DUUQU-5-F | 4.0 | ε(20° C., 1 kHz) c = 5010 |
| 4 | GUUQU-3-N | 7.0 | ε(20° C., 10 Hz) c = 40200 |
| 5 | GUUQU-4-N | 10.0 | |
| 6 | GUUQU-5-N | 3.0 | |
| 7 | GUZU-4-N | 19.0 | |
| 8 | GUZU-5-N | 14.0 | |
| | GUQU-4-N | 19.0 | |
| Σ | | 100.0 | |

c) value upon cooling,

### Mixture Example 6

The following mixture (M-6) is prepared.

Mixture M-6

| Composition | | | |
|---|---|---|---|
| Compound | | Concentration | |
| No. | Abbreviation | /% by weight | Physical properties |
| 1 | DUUQU-3-F | 12.0 | T(N, I) = 87° C. |
| 2 | DUUQU-4-F | 10.0 | T(FerroN) c = 21° C. |
| 3 | DUUQU-5-F | 4.0 | ε(20° C., 1 kHz) c = 5010 |
| 4 | GUUQU-3-N | 6.0 | ε(20° C., 10 Hz) c = 39800 |
| 5 | GUUQU-4-N | 10.0 | |
| 6 | GUUQU-5-N | 3.0 | |
| 7 | GUZU-4-N | 20.0 | |
| 8 | GUZU-5-N | 15.0 | |
| | GUQU-4-N | 20.0 | |
| Σ | | 100.0 | |

c) value upon cooling,

### Mixture Example 7

The following mixture (M-7) is prepared.

Mixture M-7

| Composition | | | |
|---|---|---|---|
| Compound | | Concentration | |
| No. | Abbreviation | /% by weight | Physical properties |
| 1 | DUUQU-3-F | 12.0 | T(N, I) = 88° C. |
| 2 | DUUQU-4-F | 12.0 | T(FerroN) c = 35° C. |
| 3 | DUUQU-5-F | 4.0 | ε(20° C., 1 kHz) c = 5580 |
| 4 | GUUQU-3-N | 7.0 | ε(20° C., 10 Hz) c = 36000 |
| 5 | GUUQU-4-N | 11.0 | |
| 6 | GUUQU-5-N | 3.0 | |
| 7 | GUZU-4-N | 15.0 | |
| 8 | GUZU-5-N | 10.0 | |
| 9 | GUQU-4-N | 15.0 | |
| 10 | UUZU-4-N | 3.0 | |
| 11 | UUZU-5-N | 3.0 | |
| 12 | UUQU-5-N | 5.0 | |
| Σ | | 100.0 | |

Remark: t.b.d.: to be determined.
c) value upon cooling,

### Mixture Example 8

The following mixture (M-8) is prepared.

Mixture M-8

| Composition | | | |
|---|---|---|---|
| Compound | | Concentration | |
| No. | Abbreviation | /% by weight | Physical properties |
| 1 | DUUQU-3-F | 12.0 | T(N, I) = 88° C. |
| 2 | DUUQU-4-F | 12.0 | T(FerroN) c = 39° C. |
| 3 | DUUQU-5-F | 4.0 | ε(20° C., 1 kHz) c = 5380 |
| 4 | GUUQU-3-N | 7.0 | ε(20° C., 10 Hz) c = 37800 |
| 5 | GUUQU-4-N | 11.0 | |
| 6 | GUUQU-5-N | 3.0 | |
| 7 | GUZU-4-N | 13.0 | |
| 8 | GUZU-5-N | 8.0 | |
| 9 | GUQU-4-N | 13.0 | |
| 10 | UUZU-4-N | 5.0 | |
| 11 | UUZU-5-N | 5.0 | |
| 12 | UUQU-5-N | 7.0 | |
| Σ | | 100.0 | |

Remark: t.b.d.: to be determined.
c) value upon cooling,

### Mixture Example 9

The following mixture (M-9) is prepared.

Mixture M-9

| Composition | | | |
|---|---|---|---|
| Compound | | Concentration | |
| No. | Abbreviation | /% by weight | Physical properties |
| 1 | DUUQU-3-F | 12.0 | T(N, I) = 89° C. |
| 2 | DUUQU-4-F | 12.0 | T(FerroN) c = 44° C. |
| 3 | DUUQU-5-F | 4.0 | ε(20° C., 1 kHz) c = 5530 |
| 4 | GUUQU-3-N | 7.0 | ε(20° C., 10 Hz) c = 36200 |
| 5 | GUUQU-4-N | 11.0 | |
| 6 | GUUQU-5-N | 3.0 | |
| 7 | GUZU-4-N | 11.0 | |
| 8 | GUZU-5-N | 6.0 | |
| 9 | GUQU-4-N | 11.0 | |
| 10 | UUZU-4-N | 7.0 | |
| 11 | UUZU-5-N | 7.0 | |
| 12 | UUQU-5-N | 9.0 | |
| Σ | | 100.0 | |

Remark: t.b.d.: to be determined.
c) value upon cooling,

### Mixture Example 10

The following mixture (M-10) is prepared.

Mixture M-10

| Composition | | | |
|---|---|---|---|
| Compound | | Concentration | |
| No. | Abbreviation | /% by weight | Physical properties |
| 1 | MUU-4-N | 10.0 | T(N, I) = 107° C. |
| 2 | MUU-5-N | 5.0 | T(FerroN)c = 30° C. |
| 3 | UMU-4-N | 10.0 | |
| 4 | UMU-5-N | 5.0 | |
| 5 | UMU-6-N | 5.0 | |
| 6 | GUUQU-3-N | 15.0 | |
| 7 | GUUQU-4-N | 10.0 | |
| 8 | GUUQU-5-N | 10.0 | |
| 9 | DUUQU-3-F | 10.0 | |
| 10 | DUUQU-4-F | 10.0 | |
| 11 | DUUQU-5-F | 10.0 | |
| Σ | | 100.0 | |

c)value upon cooling,

### Mixture Example 11

The following mixture (M-11) is prepared.

Mixture M-11

| Composition | | | |
|---|---|---|---|
| Compound | | Concentration | |
| No. | Abbreviation | /% by weight | Physical properties |
| 1 | MUU-4-N | 7.0 | T(N, I) = 108° C. |
| 2 | MUU-5-N | 4.0 | T(FerroN)c = 28° C. |
| 3 | UMU-4-N | 7.0 | |
| 4 | UMU-5-N | 4.0 | |
| 5 | UMU-6-N | 3.0 | |
| 6 | GUUQU-3-N | 15.0 | |
| 7 | GUUQU-4-N | 13.0 | |
| 8 | GUUQU-5-N | 12.0 | |
| 9 | DUUQU-3-F | 7.0 | |
| 10 | DUUQU-4-F | 9.0 | |
| 11 | DUUQU-5-F | 4.0 | |
| 12 | GUZU-4-N | 5.0 | |
| 13 | GUZU-5-N | 5.0 | |
| 14 | GUQU-4-N | 5.0 | |
| Σ | | 100.0 | |

c)value upon cooling,

### Mixture Example 12

The following mixture (M-12) is prepared.

Mixture M-12

| Composition | | | |
|---|---|---|---|
| Compound | | Concentration | |
| No. | Abbreviation | /% by weight | Physical properties |
| 1 | MUU-5-N | 4.0 | T(N, I) = 104° C. |
| 2 | UMU-4-N | 7.0 | T(FerroN)c = 30° C. |
| 3 | UMU-5-N | 4.0 | |
| 4 | GUUQU-3-N | 13.0 | |
| 5 | GUUQU-4-N | 13.0 | |
| 6 | GUUQU-5-N | 12.0 | |
| 7 | DUUQU-3-F | 9.0 | |
| 8 | DUUQU-4-F | 9.0 | |
| 9 | DUUQU-5-F | 4.0 | |
| 10 | GUZU-4-N | 10.0 | |
| 11 | GUZU-5-N | 5.0 | |
| 12 | GUQU-4-N | 10.0 | |
| Σ | | 100.0 | |

c)value upon cooling,

### Mixture Example 13

The following mixture (M-13) is prepared.

Mixture M-13

| Composition | | | |
|---|---|---|---|
| Compound | | Concentration | |
| No. | Abbreviation | /% by weight | Physical properties |
| 1 | MUU-5-N | 6.0 | T(N, I) = 103° C. |
| 2 | UMU-4-N | 8.0 | T(FerroN)c = 20° C. |
| 3 | UMU-5-N | 6.0 | |
| 4 | GUUQU-3-N | 13.0 | |
| 5 | GUUQU-4-N | 13.0 | |
| 6 | GUUQU-5-N | 12.0 | |
| 7 | DUUQU-3-F | 7.0 | |
| 8 | DUUQU-4-F | 7.0 | |
| 9 | DUUQU-5-F | 3.0 | |
| 10 | GUZU-4-N | 10.0 | |
| 11 | GUZU-5-N | 5.0 | |
| 12 | GUQU-4-N | 10.0 | |
| Σ | | 100.0 | |

c) value upon cooling,

### Evaluation Example 1

A capacitor comprising two glass substrates with ITO electrodes is filled with a layer of 110 μm of dielectric consisting of the medium of Mixture Example 1. A capacitance of 1.41 μF is determined using a 10 Hz alternating voltage. The resulting relative dielectric permittivity (εᵣ) of the medium is 4.2. 10⁴.

### Device Example 2

### Preparation:

A capacitor comprising two glass substrates (25 mm×35 mm) with ITO electrodes at a distance of 750 μm is prepared. The two long sides edges are sealed with a combination of UV resin and a thin glass tube, which acts as spacer. Electrical connection between the two ITO electrodes and an electrical voltage source is made via the edges of the glass. One of the open sides of the capacitor is placed into a bulk reservoir of the LC medium of Mixture Example 1, while the glass substrates are in a vertical position. The N_{f}-LC medium enters the open space between the substrates up to the level of the bulk liquid. The glass is marked with a vertical length scale starting from the meniscus of the liquid medium.

### Electromechanical Operation (DC):

The device is supplied with electric voltage of 10, 20, 30 and 40 V DC. The level of the medium inside the capacitor rises up against gravity until a new equilibrium position is reached. The ultimate level reached by the LC medium is proportional to the employed voltage. The initial vertical speed of filling is also positively correlated to the applied voltage (Table).

TABLE
Filling time of the capacitor versus applied voltage (DC)

| Voltage | Time for filling the volume |
|---|---|
| 10 V | 26 s |
| 20 V | 7 s |
| 30 V | 4 s |
| 40 V | 3 s |

Temperature dependence and comparative device

The device was operated at 20° C. and at 50° C. At 50° C. the LC medium of the device was in a conventional nematic state (non-ferroelectric). While the operation at 20° C. is as described above, at 50° C. there is no visible change in the level of the LC medium while a voltage of 40 V is applied.

The non-ferroelectric nematic liquid crystal media do not respond to electric signals, because the electromechanical response is smaller by several orders of magnitude.

### Device Example 3

The device of Device Example 2 is maintained for this setup, but the electrical signal is varied.

### Electromechanical Operation (AC):

The device of Device Example 2 is supplied with electric voltage of alternating current (5 Hz/20 Hz) at 80 V. The device fills at lower speed than with DC voltage.

The device was able to adapt to the changing polarization of the electric source, however the frequent commutation diminishes the net power conversion.

### Device Example 4. Piston Actuator

Piston machine according to FIG. 2 is filled with medium according to Mixture Example 1. The piston moves towards the electrodes with electric potential.

### Details:

The setup is in analogy to FIG. 2. An amount of about 1 g of medium according to Mixture Example 1 is filled in a flat container consisting of thin glass plates with sealing on the edges. The container is suspended vertically on a long thread from above and placed on the border between two pairs of flat electrodes fitting closely to the thickness of the container. When applying a voltage (40 V) at one pair of electrodes the container moves to the electrodes by the force of the electric field on the dielectric. When the electrodes are grounded the container recedes to its starting position. The container can be moved from one to the other electrode by exchanging electric signals and grounding of the two pairs of electrodes.

For a piston with a dielectric with εᵣ of 42000 of 1 cm² diameter (parallel to the electric field) in a field of 100 Vcm⁻¹ the force is about 2.10-3 N.

### Device Example 5. Variation of Piston Actuator

Electro-mechanical conversion machine with piston according to FIG. 3

Instead of LC filled container according to Device Example 4 a non-ferroelectric low εᵣ piston (thermoplastic) is moving in a ferroelectric nematic LC medium between capacitor plates. The electric field sucks in medium and pushes piston out of electrical field.

### Details:

A flat piece of plastic is confined loosely in a closed container containing ferroelectric nematic LC medium. The plastic part fills about 40% of the volume of the container and can move laterally. The container has two pairs of electrodes on the surfaces as in FIG. 3. When using glass plates as container the movement of the plastic part can be observed. Upon using suitable electric signals on the electrodes (see Device Example 4) the plastic parts can move from one the other pair of electrodes and acts like a piston in the medium.

### Device Example 6. Circular Motor According to FIG. 4a/4b

A motor in accordance with the illustrated outlines can be made from 3D printing suitable plastic parts with thin walls. The construction material is selected to be suitable for organic substances, however solubility in highly fluorinated media with high molecular weights as the ones employed here is mostly acceptably low. A disc-shaped rotor with 6 cm diameter with suitable sector shaped cavities for the LC medium is printed, filled with medium of Mixture Example 1 and sealed. The sections with no cavities are partly thermoplastic and air, as necessitated for stability during rotation. The outside shape of the rotor is designed flat in order not to have too much abrasion on the electrodes in case of contact. The rotor is placed on an axis and is positioned as closely as possible with a small gap between the sectored pairs of electrodes. The electrodes are addressed with alternating phase DC voltage of variable amplitude. The rotation is initiated by external impulse. The rotation speed is determined by the frequency of the phase sequence of the voltage source.

1. An electro-mechanical conversion machine comprising two or more electrodes for generating an electric field in a space volume distributed between at least two of the electrodes, and a dielectric material positioned at least partly in the space volume of said electric field between at least two of the electrodes,
wherein the dielectric material can assume spatially variable positions in relation to the electrodes, and
wherein the dielectric material comprises one or more liquid crystalline (LC) materials in a ferroelectric nematic phase, wherein said ferroelectric nematic LC material comprises at least two compounds with a molecular structure of formula I, 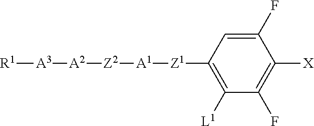
wherein
A¹ denotes 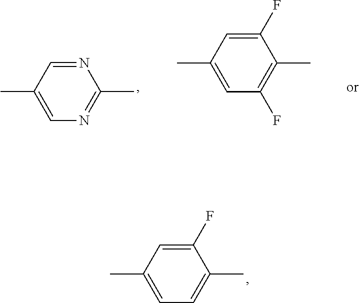
A² denotes 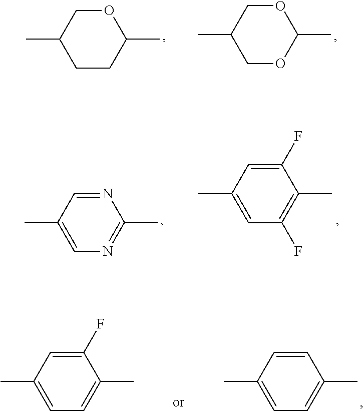
A³ denotes 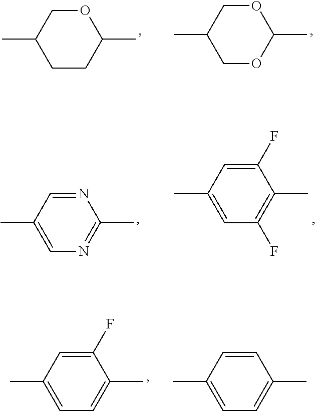
or a single bond,
R¹ is an alkyl radical having 1 to 12 C atoms, where, in addition, one or more CH₂ groups in these radicals may in each case be replaced, independently of one another, by —C═C—, —CF₂—O—, —OCF₂—, —CH═CH—, 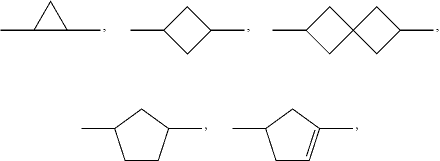
—O—, —S—, —(CO)—O— or —O—(CO)— in such a way that O/S atoms are not linked directly to one another, and in which, in addition, one or more H atoms may be replaced by halogen, or denotes H,
X is CN, F, CF₃, —OCF₃, —NCS, Cl, preferably CN or F,
L¹ is H or CH₃,
Z¹ is CF₂O or —(CO)—O— or a single bond, and
Z² is CF₂O or —(CO)—O— or a single bond.

2. The electro-mechanical conversion machine according to claim 1, comprising as dielectric a liquid crystalline medium comprising 10% by weight or more of one or more compounds of formula IA, 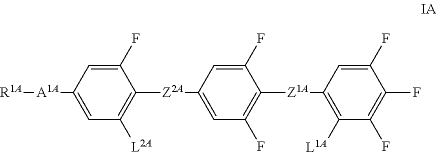
10% by weight or more of one or more of compounds of formula IB, 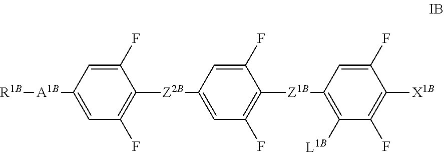
and 10% by weight or more of one or more compounds selected from formula IC-1 to IC-3 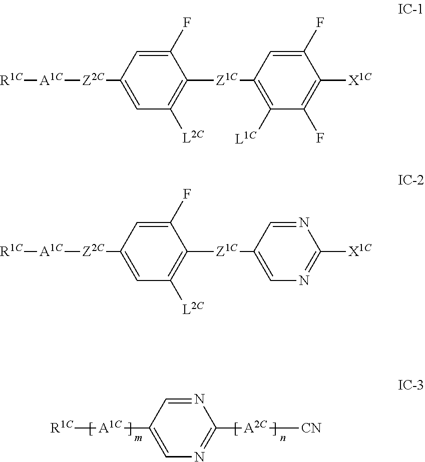
in which
X^{1B} denotes —CN or —NCS,
X^{1C} denotes —CN, F, CF₃, —OCF₃, —NCS, SF₅ or O—CF═CF₂, preferably —CN or F,
Z^{1A} and Z^{1B} independently of one another denote —(CO)—O— or —CF₂—O— or a single bond,
Z^{2A} and Z^{2B} independently of one another denote a single bond, (CO)—O— or —CF₂—O—,
Z^{1C} and Z^{2C} one of the both groups denotes —(CO)—O— or —CF₂—O— and the other a single bond,
L^{1A}, L^{1B} and L^{1C} independently of each other denote H or CH₃,
L^{2A} is F or H,
L^{2C} is F or H,
A^{1A} denotes 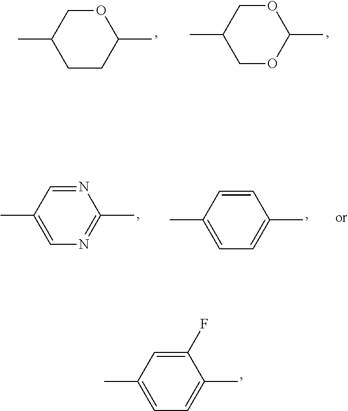
A^{1B} denotes 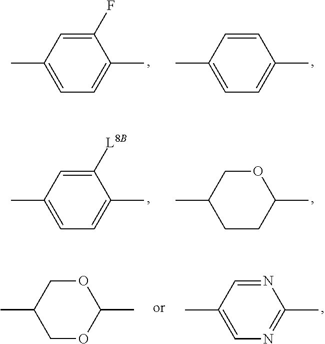
wherein L^{8B} denotes alkyl, alkoxy or alkoxyalkyl, each with 1 to 7 C atoms,
A^{1C} denotes 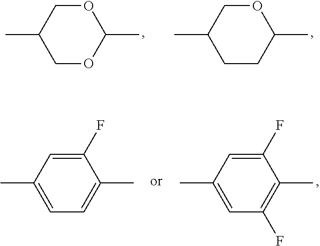
A^{2C} denotes 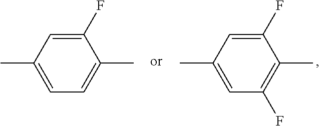
m, n 0, 1 or 2, where (m+n) is 1,
R^{1A}, R^{1B} and R^{1C} independently of each another denote an alkyl radical having 1 to 12 C atoms, where, in addition, one or more CH₂ groups in these radicals may in each case be replaced, independently of one another, by —C═C—, —CF₂—O—, —OCF₂—, —CH═CH—, 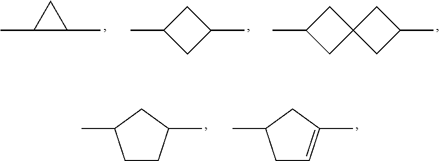
—O—, —S—, —(CO)—O— or —O—(CO)— in such a way that O/S atoms are not linked directly to one another, and in which, in addition, one or more H atoms may be replaced by halogen, or denotes H.

3. The electro-mechanical conversion machine according to claim 1, wherein the LC material exhibits a ferroelectric nematic phase at a temperature from 10° C. to 30° C.

4. The electro-mechanical conversion machine according to claim 1, wherein the LC material exhibits a relative dielectric permittivity εᵣ of 15000 or more at 20° C. and 10 Hz.

5. The electro-mechanical conversion machine according to claim 1, where the machine is configured to transform electric signals into motion.

6. The electro-mechanical conversion machine according to claim 1, which is a linear electromechanical actuator which transforms electric signals into a linear motion.

7. Electro-mechanical conversion machine according to claim 1, where the liquid dielectric material is confined in a container.

8. Electro-mechanical conversion machine according to claim 1, where the dielectric material is positioned in a flow path in said space volume and said spatially variable positions of the dielectric material correspond to a flow motion of the dielectric material in said flow path.

9. Electro-mechanical conversion machine according to claim 1, where the machine is an electric motor, which transforms electric signals into a circular motion.

10. Electro-mechanical conversion machine according to claim 1, which transforms mechanical motion into electric signals.

11. Electro-mechanical conversion machine according to claim 1, which is a micro electromechanical system having a distance of two electrodes across the space volume of 1 mm or less or which is integrated with an electronic structure on a semiconductor chip.

12. An electro-mechanical conversion machine, comprising a liquid crystalline material with a ferroelectric nematic phase according to claim 1 as a dielectric material.

13. A method of preparation of an electro-mechanical conversion machine comprising inserting a liquid crystalline medium as dielectric material according to claim 1 into a defined space volume and attaching two or more electrodes, where the electrodes define a second space volume distributed between at least two of the electrodes, and the dielectric material is positioned in contact with or partly inside the second space volume.

14. The electro-mechanical conversion machine of claim 12, comprising an electromechanical actuator, a motor, or an electrical generator.
